(19) United States
(12) Patent Application Publication
(10) Pub. No.: US 2015/0142602 A1
(43) Pub. Date: May 21, 2015

(54) METHOD AND SYSTEM FOR AUTOMATED IDENTIFICATION AND ENGAGEMENT OF SERVICE PROVIDERS

(71) Applicant: SERVICE LABS, INC., Seattle, WA (US)

(72) Inventors: Matthew Todd Williams, Seattle, WA (US); Gregor Neal Purdy, Seattle, WA (US); Eric Chandler Wilson, Seattle, WA (US); Rajalakshmi Iyer Subramanian, Chennai (IN); Heidi Susan Robinson, Seattle, WA (US); Balaji Damodaran, Chennai (IN); Mark Addison Winham, Seattle, WA (US); Madan Kumar Rajan Natarajan, Chennai (IN); Brian John Moco, Seattle, WA (US); Jon Sorensen, Seattle, WA (US); Mahul Himat Shah, Chennai (IN); Arun Kumar Rajan Natarajan, Chennai (IN)

(73) Assignee: SERVICE LABS, INC., Seattle, WA (US)

(21) Appl. No.: 14/547,458

(22) Filed: Nov. 19, 2014

Related U.S. Application Data
(60) Provisional application No. 61/906,036, filed on Nov. 19, 2013.

(51) Int. Cl. G06Q 30/06

(52) U.S. Cl. CPC G06Q 30/0631
USPC 705/26.7

(57) ABSTRACT

The current document is directed to methods and systems that identify projects for which service consumers desire service provision and identify available candidate service providers that best match various project parameters and service-provision criteria determined by the automated system. Information describing the identified candidate service providers is presented to the service consumers by the systems to allow service consumers in order to facilitate their selection of service providers and scheduling of service provision. In one described implementation, service providers are matched to stock-keeping-unit (“SKU”) identifiers and location or locations. Service providers identified in the initial SKU-and-location-based matching process are then scored and ranked according to additional criteria and constraints, with information describing the highest-ranked service candidate providers provided to service consumers for selection and scheduling.

### CROSS-REFERENCE TO RELATED APPLICATION

This application claims the benefit of Provisional Application No. 61/906,036, filed Nov. 19, 2013.

### TECHNICAL FIELD

The current document is directed to automated methods for matching service providers to service consumers and, in particular, to a distributed computer system, and methods incorporated within the distributed computer system, that provides an automated service for identifying service needs of service consumers, identifying service providers able to provide needed services to service consumers, scheduling service provision, and monitoring service provision.

### BACKGROUND

During the past 20 years, advancements in computing, data-storage, and networking technologies along with the development and widespread adoption of the World Wide Web have together spawned Internet-based retailing, or e-commerce, which has revolutionized marketing and retailing of products throughout the world. Although online shopping systems were first developed in the late 1970s and online retailing appeared in the early 1980s, e-commerce began to emerge as a serious alternative to traditional marketing and retailing in the mid 1990s. Prior to the emergence of e-commerce, the vast majority of retail sales were conducted in physical commercial retail establishments and by catalog-based mail-order and telephone sales. During the past 20 years, e-commerce has grown to rival traditional retailing in many areas and has overtaken traditional retailing in particular areas, including the sales of books, recorded music, entertainment tickets, and software products. It is likely that Internet-based retailing will continue to expand and further displace traditional retailing methods in coming decades.

While retailing and marketing of products represents a major arena of economic activity, retailing and marketing of services performed by various types of service providers, including individual service providers and contractors, service-oriented businesses, and various types of service-providing organizations, represents another major and increasingly important arena of economic activity. Services range from local, personal services, including lawn care, home repair, painting, and appliance repair, to services provided by individuals to organizations, such as contract-based typing and data entry, software development, and market analysis, to complex services provided to individuals and organization, including various types of professional services, information-technology services, and other such complex services, and finally to services provided by organizations and professionals, including car repair, medical services, and legal services. Unlike retailing of products, the service sector has not yet been transformed by Internet-based retailing and marketing. Internet-based retailing of services has not reached sales volumes and consumer-acceptance levels comparable to those of Internet-based product retailing. Internet-based retailing of services to service consumers therefore represents a large, as yet largely untapped area of commerce, for which new types of systems and infrastructure will continue to be sought by those attempting to apply modern technologies to service provision.

### SUMMARY

The current document is directed to methods incorporated within an automated system that identifies projects for which service consumers desire service provision and that identifies available candidate service providers that best match various project parameters and service-provision criteria determined by the automated system in order to steer automated identification and selection of candidate service providers. Information describing the identified candidate service providers is presented to the service consumers by the automated system to allow service consumers to select service providers and schedule service provision. In one described implementation, service providers are matched to stock-keeping-unit (“SKU”) identifiers corresponding to one or more projects as well as the location or locations in which services associated with the projects are to be carried out. Candidate service providers identified in the initial SKU-and-location-based matching process are then scored and ranked according to additional criteria and constraints, with information describing the highest-ranked candidate service providers provided to service consumers for selection and scheduling.

### BRIEF DESCRIPTION OF THE DRAWINGS

FIGS. 1A-L illustrate interaction between a service consumer and the currently disclosed automated system that determines projects for which service provision is desired by service consumers, matches service providers with projects to automatically create a set of candidate service providers, provides information about the candidate service providers to service consumers, and receives selections of service providers by service consumers for scheduling of service provision.

FIG. 2 provides a general architectural diagram for various types of computers.

FIG. 3 illustrates an Internet-connected distributed computer system.

FIG. 4 illustrates cloud computing. In the recently developed cloud-computing paradigm, computing cycles and data-storage facilities are provided to organizations and individuals by cloud-computing providers.

FIG. 5 illustrates generalized hardware and software components of a general-purpose computer system, such as a general-purpose computer system having an architecture similar to that shown in FIG. 1.

FIGS. 6A-B illustrate two types of virtual machine and virtual-machine execution environments.

FIG. 7 illustrates the architecture of one implementation of the currently disclosed automated system that matches service providers with server-consumer projects.

FIGS. 8A-C illustrate the types of data maintained within the automated system to provide for the service-consumer web interface that allows service consumers to create project lists and select service providers for carrying out projects in the project lists from sets of candidate service providers matched to the project lists by the automated system.

FIGS. 9A-D include control-flow diagrams that illustrate operation of the consumer-web-application servers (706 in FIG. 7).

FIG. 10 illustrates a match-processing routine that represents the service-provider matching process carried out by the automated system.

FIG. 11 illustrates the relational-database perspective on data storage.

FIG. 12 shows a pseudocode implementation of a routine “processInput” that processes certain of the input data (1004 in FIG. 10) that is input to the match-processing process (1002 in FIG. 10).

FIG. 13 shows four SQL commands that carry out initial selection of providers from the relational database that contains the relational-database tables discussed above with reference to FIGS. 8A-C and FIG. 11.

FIG. 14 shows a number of pseudocode constant declarations and a type declaration used in subsequent pseudocode descriptions of the remaining portion of the provider-matching process.

FIG. 15 provides pseudocode for a routine “scoreProviders” that computers scores for the initial set of candidate providers.

FIGS. 16-18 provide pseudocode implementations of the seven routines, called in the pseudocode block 1516 shown in FIG. 15 of the routine “scoreProviders,” that compute component scores subsequently added together to form the match score for a service provider.

FIGS. 19 and 20 provide control-flow diagrams that illustrate implementation of the processing routine that carries out the service-provider matching process discussed above with reference to FIGS. 11-18.

### DETAILED DESCRIPTION

The current document is directed to methods incorporated within an automated system that allows service consumers to identify suitable service providers and schedule service provision by the service providers. In a first subsection, below, an example interaction between a service consumer and the automated system is provided with reference to illustrations of web pages that are generated by the automated system and viewed by the service consumer during the interaction. In a second subsection, an overview of the automated system is provided. In a third subsection, a detailed discussion of the methods, incorporated within the automated system, that identify service providers for selection by service consumers is provided, along with illustrations, diagrams, and pseudo code.

### An Example Interaction Between a Service Consumer and an Automated System that Identifies Service Providers for Selection and Scheduling by Service Consumers

In the following discussion, the phrase “the automated system” is used to refer to a distributed computer system that implements automated methods for matching service providers to service consumers. The phrase “the automated system” encompasses many different implementations, one of which is disclosed, in detail, in a following subsection. The automated system is a complex, physical, distributed computer system that provides automated services, carries out automated transactions, and that collects and distributes information through physical communications systems. The automated services provided by the automated system cannot be provided manually or by other traditional, non-computational methods.

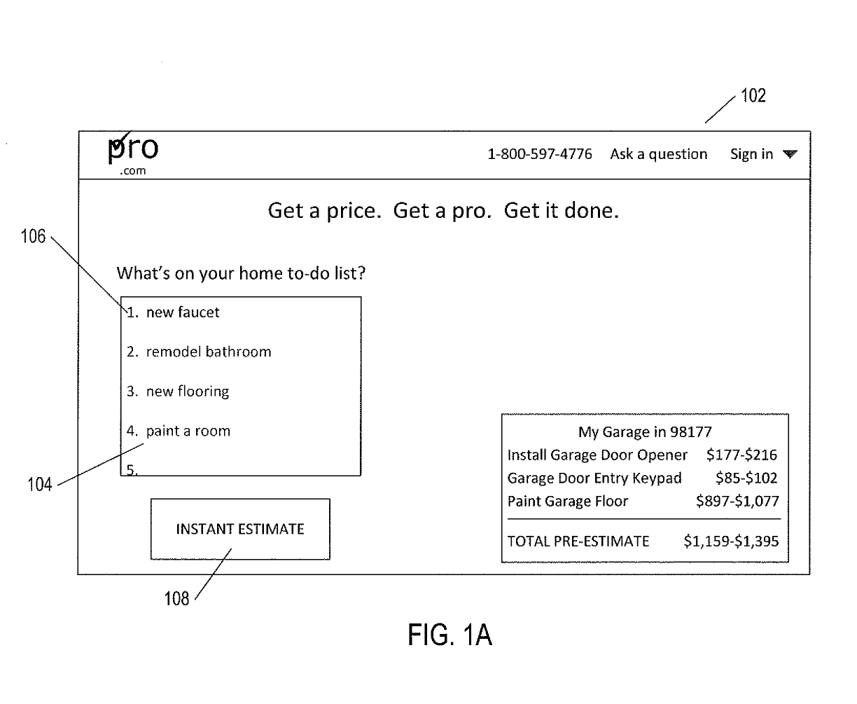

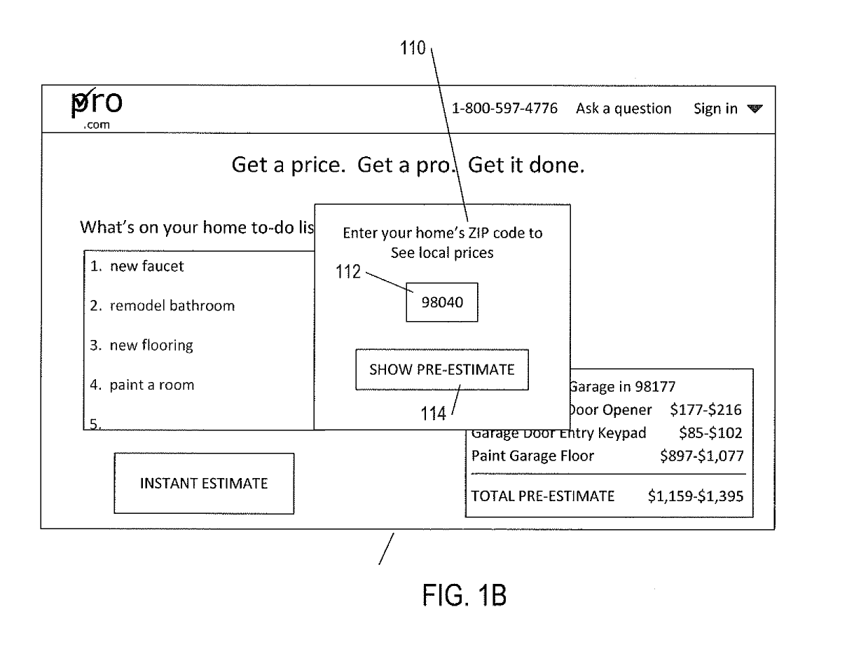

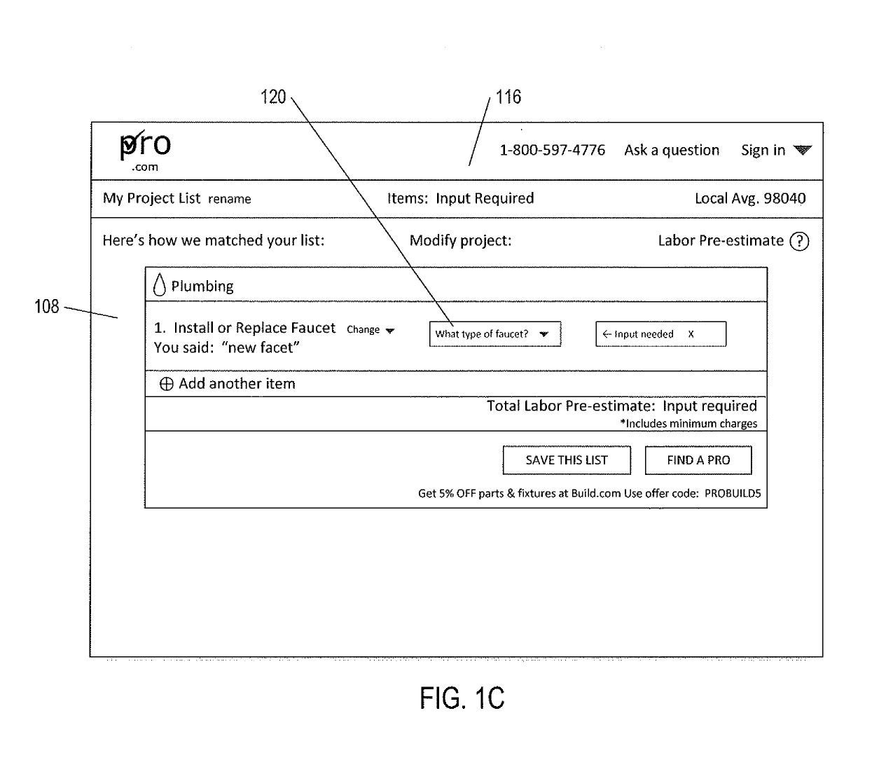

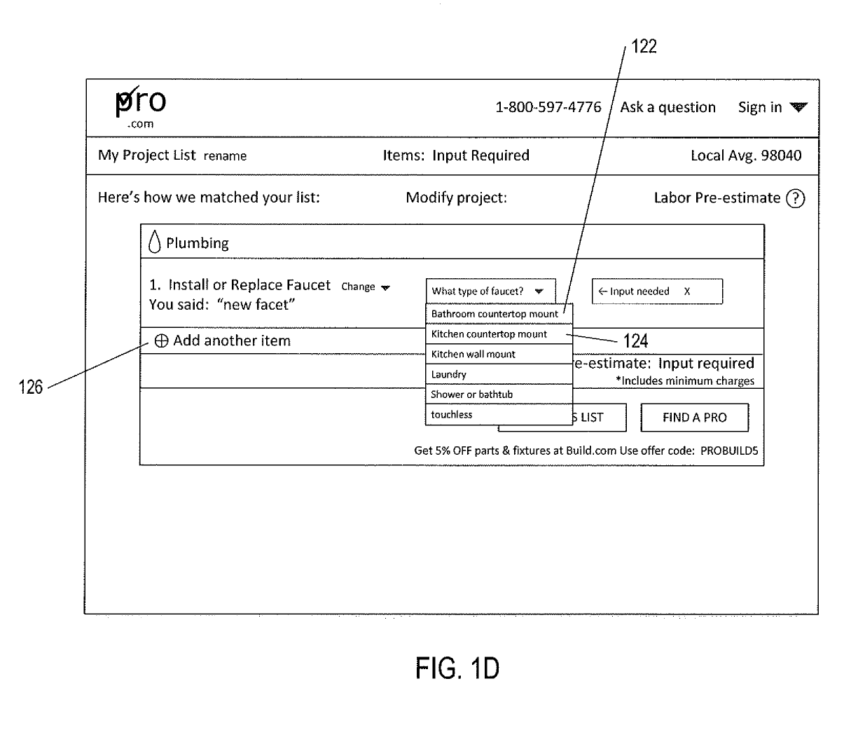

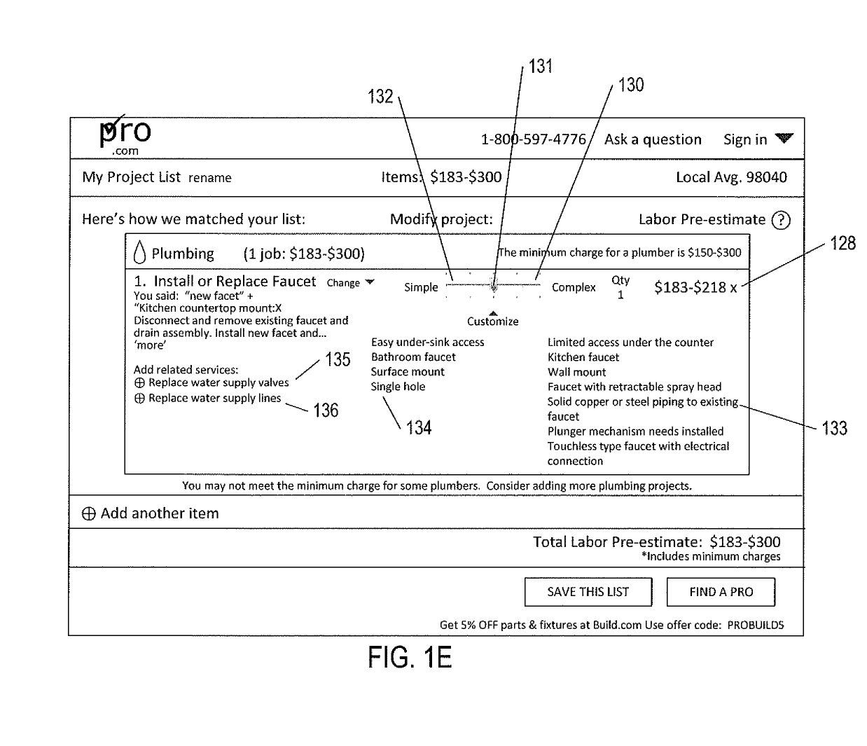

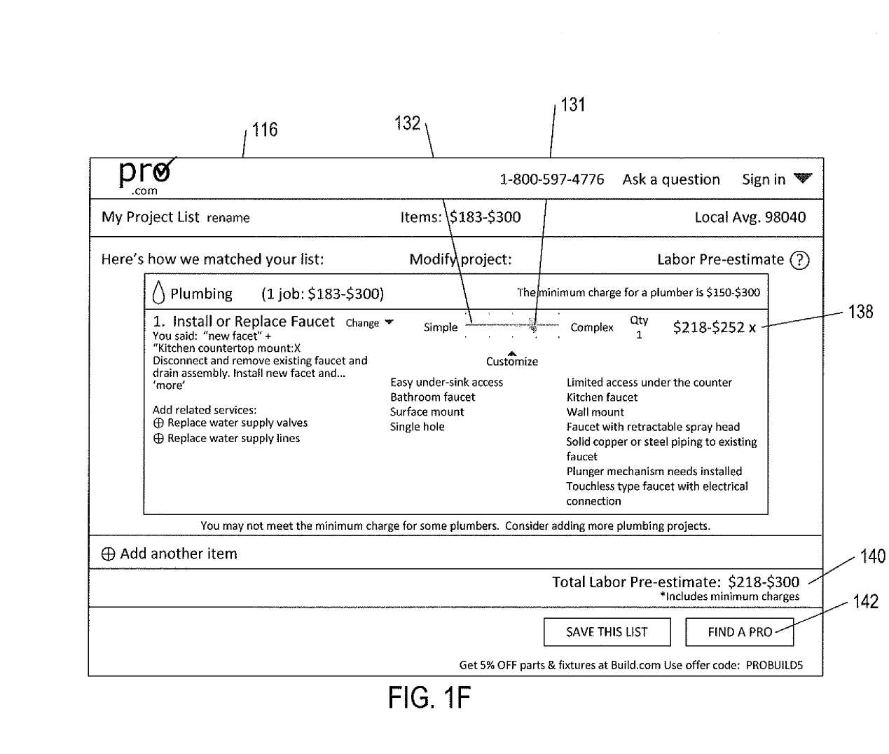

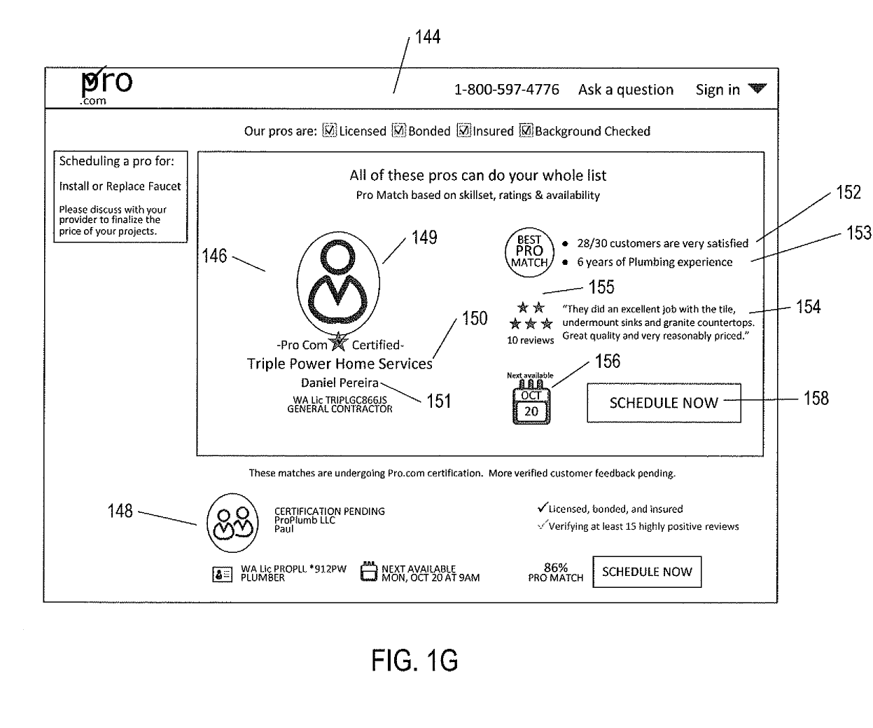

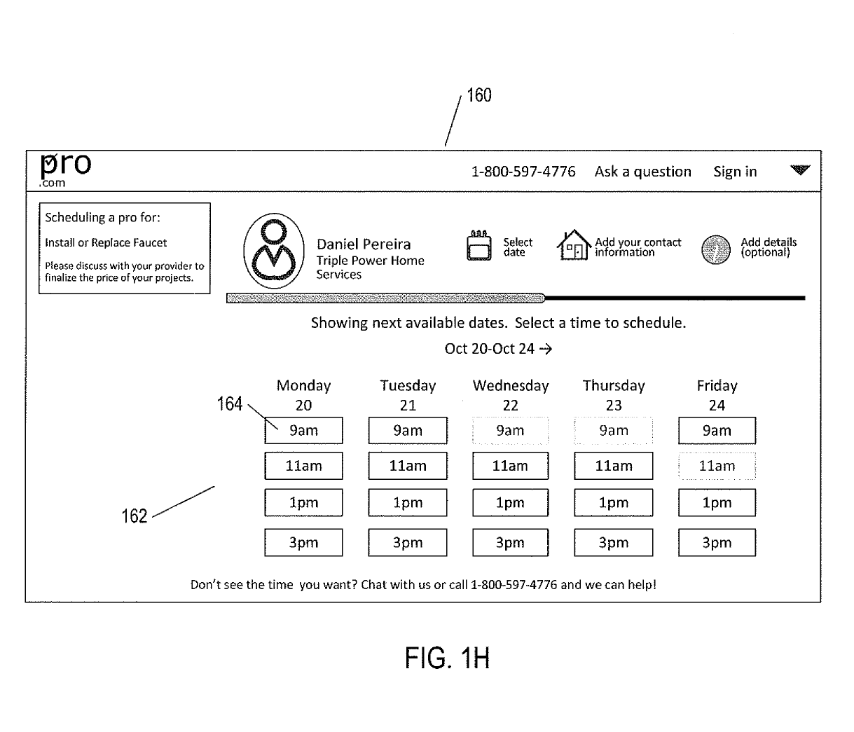

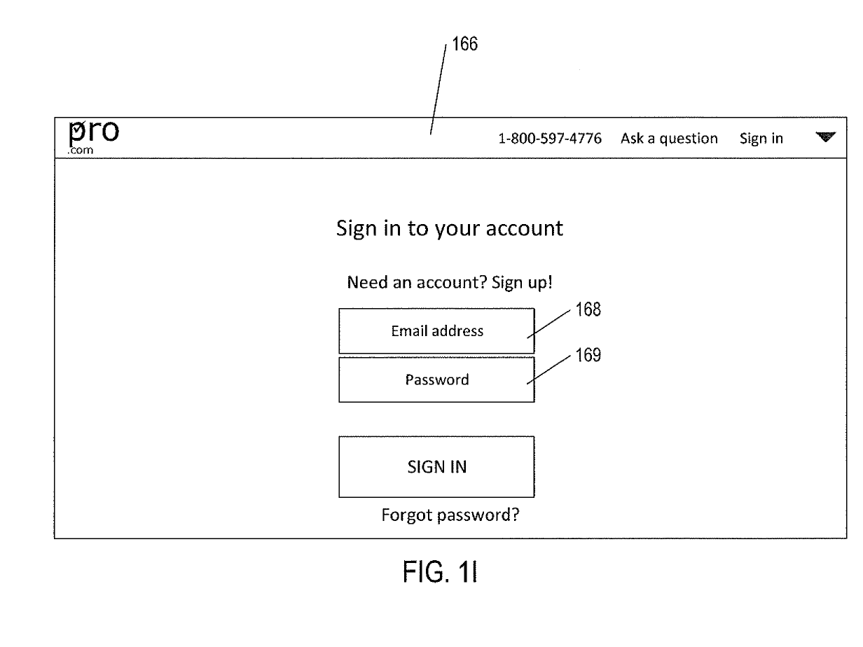

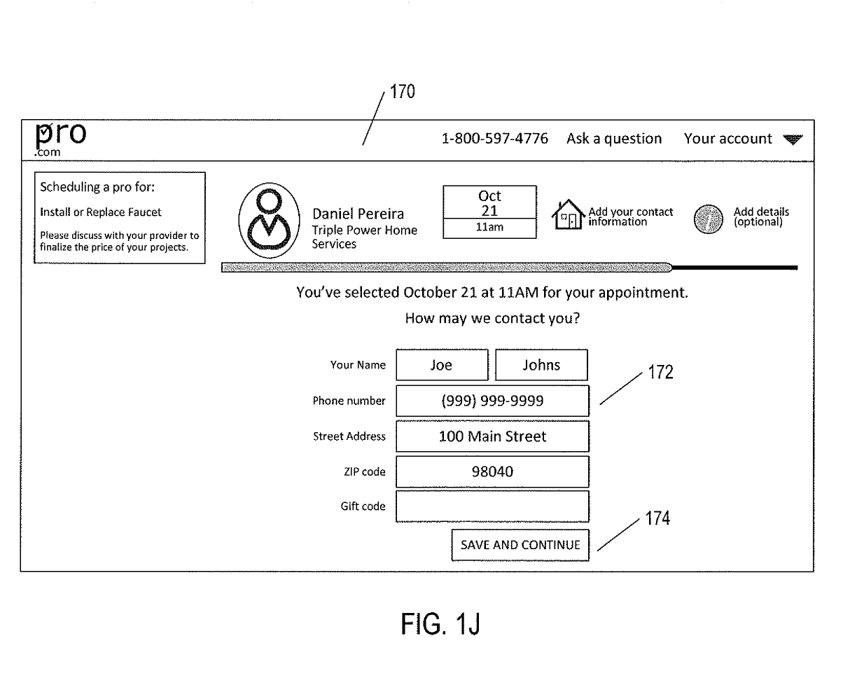

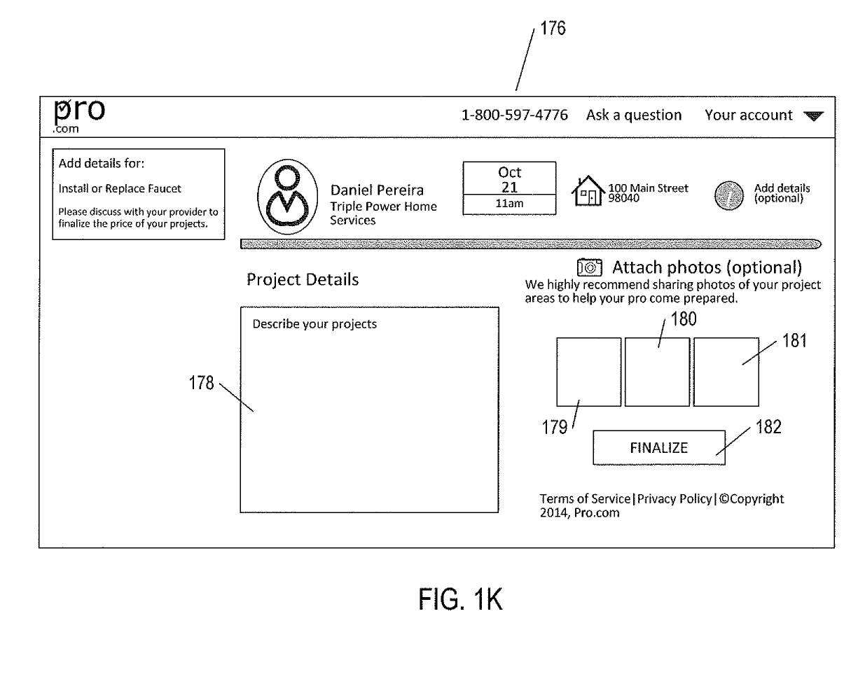

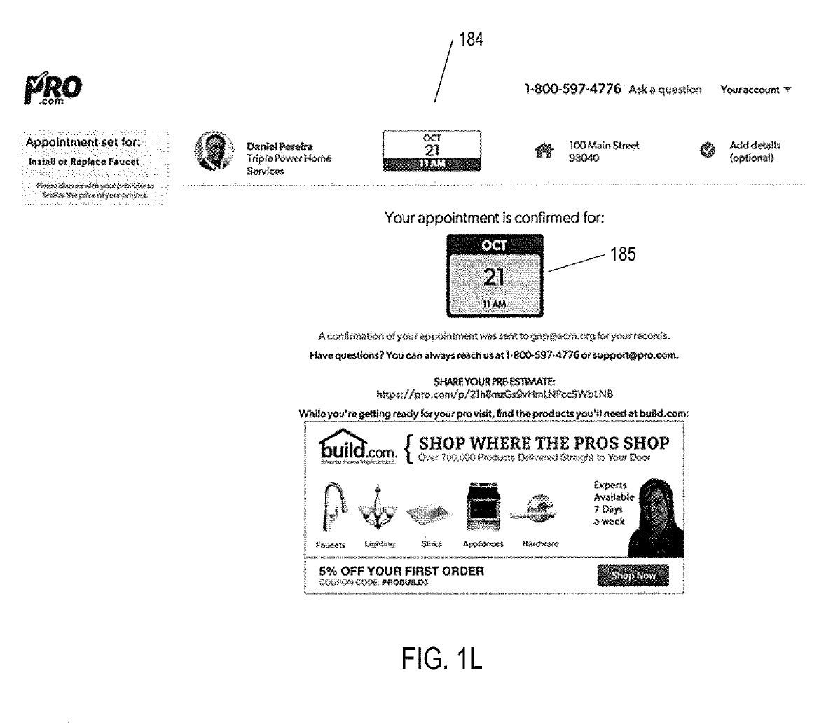

FIGS. 1A-L illustrate interaction between a service consumer and the currently disclosed automated system that determines projects for which service provision is desired by service consumers, matches service providers with projects to automatically create a set of candidate service providers, provides information about the candidate service providers to service consumers, and receives selections of service providers by service consumers for scheduling of service provision. The interaction between the service consumer and automated system is illustrated, in FIGS. 1A-L, with screen shots of web pages transmitted by the automated system to the service consumer's web browser for display to the service consumer on an electronic device, such as a personal computer, mobile phone, notebook, pad, or other Internet-connected electronic device. The service consumer initially accesses a home page provided by one or more web servers within the automated system via a browser bookmark, a link embedded within search-engine results, through hyperlinks included in various web-services aggregation pages, or by other familiar web-page-navigation methods.

FIG. 1A shows an initial web page 102 displayed to the service consumer by the service consumer's web browser. The initial web page provides a text-entry window 104 into which the service consumer may enter phrases that represent various projects for which the service consumer wishes to find and schedule a service provider. As shown in FIG. 1A, the service consumer has entered a project described by the phrase “new faucet” 106. The service consumer may enter an arbitrary number of project descriptions. Initial suggestions are displayed in the text-entry window in a faded text display to indicate the types of entries that can be made by the service consumer. When the service consumer has finished entering descriptions of projects for which the service consumer wishes to schedule a service provider, the service consumer inputs a mouse click to an “instant estimate” button 108. The mouse click directs the service consumer's browser to return the project list to the automated system and request a next interaction. In response, the automated system returns a pop-up request for the service consumer's zip code, shown in FIG. 1B. The pop-up zip-code request 110 includes a zip-code entry feature 112 into which the service consumer enters a zip code for the location where the one or more previously specified projects are to be carried out.

Following entry of the zip code, the service consumer inputs a mouse click to the “show pre-estimate” feature 114. Input of the mouse click to the “show pre-estimate” feature directs the service consumer's browser to return the zip code to the automated system. In response, the automated system returns a second web page to the service consumer's browser. FIG. 1C shows a screen shot of the second web page 116 displayed to the service consumer by the service consumer's browser. The second web page 116 displays an entry 118 for the new-faucet project previously described by the service consumer. The second web page displays an additional-information-request feature 120. When the service consumer inputs a mouse click to this additional-information-request feature 120, the service consumer's web browser returns a request for more information to the automated system which, in return, transmits a list of faucet types to the service consumer's web browser. The service consumer's web browser displays the returned list of faucet types in a drop-down information display 122 shown in FIG. 1D. Mouse-mediated selection of the “kitchen countertop mount” 124 by the service consumer results in the service consumer's web browser returning the kitchen-countertop-mount selection to the automated system. Note that, in the second web page 116 shown in FIGS. 1C-D, the service consumer may add additional projects via the “add another item” feature 126. In the current example, the service consumer is seeking only installation of a faucet and therefore does not input a mouse click to this feature.

FIG. 1E shows the second web page that has been modified in response to the service consumer's selection of the “kitchen countertop mount” entry 124 in the drop-down information display 122. The automated system has returned additional information that is now displayed for the faucet-replacement project. This information includes an initial price estimate 128 and a slider feature 130 that allows the user to indicate, by sliding a button 131 horizontally along a slider bar 132, the complexity of the faucet-replacement project. Characteristics and parameters that would indicate a more complex project are shown below the word “complex” 133 and characteristics and parameters that would indicate a more simple project 134 are displayed below the word “simple” Additional-services features 135 and 136 allow the service consumer to request additional services related to the faucet-replacement project.

As shown in FIG. 1F, the service consumer has adjusted the slider button 131 rightward along the horizontal slider bar 132 to indicate more than average complexity, as a result of which, through an exchange of information with the automated system, the service consumer's web browser now displays a revised estimate 138 for the cost of having the project completed. Note also that a total pre-estimate 140 is displayed towards the bottom of the second web page 116. The total pre-estimate price includes additional charges that may result from a minimum charge required by potential service providers.

At this point in the interaction, with the project fully described, the service consumer may input a mouse click to the “find a pro” feature 142 to indicate a desire to review a list of one or more candidate service providers capable of carrying out the described project or projects. Input of the mouse click to the “find a pro” feature 142 directs the service consumer's browser to transmit a request to the automated system for a third web page that displays candidate service providers for the service consumer's project. FIG. 1G shows an example third web page returned by the automated system. The third web page 144 displays information about a highest-ranked service provider 146 who can repair or install faucets in the geographical location indicated for the project by the service consumer. When additional lower-ranked service providers are available, information about the additional candidate service providers 148 may also be displayed on the third web page. Information displayed regarding the highest-ranked candidate service provider includes a photograph 149, the name of the service provider's company 150, the name of the service provider 151, an indication of the reviews provided by previous customers of the service provider 152, an indication of the service provider's experience 153, text extracted from one of the favorable reviews 154, an indication of the average rating provided by reviewers 155, and the date of the next available appointment time 156 for the service provider. The displayed information may include hyperlinks to the full text of reviews provided by customers of the service provider.

When the service consumer inputs a mouse click to the “schedule now” input feature 158, the service consumer's web browser carries out an additional information exchange with the automated system in order to obtain appointment-time/schedule information for the service provider associated with the “schedule now” feature. The automated system returns a fourth web page, as shown in FIG. 1H. The fourth web page 160 provides a partial calendar 162 that lists upcoming available appointment times and already-booked appointment times for the selected service provider. The available appointment times are shaded, such as the shaded feature for the two-hour appointment time 164 beginning at 9:00 am on Monday, October 20^{th}. Input, by a service consumer, of a mouse click to an available appointment-time feature, such as feature 164, results in yet an additional information exchange with the automated system. In the current case, the automated system returns a fifth web page requesting the service consumer to log in to the service consumer's account or to set up a new account.

The fifth web page of the transaction is shown in FIG. 1I. Input of the service consumer's email address to input feature 168 of the fifth web page 166 and input of the service consumer's password to input feature 169 initiates an additional information exchange between the service consumer's web browser and the automated system, resulting in display of a modified fourth web page, shown in FIG. 1J, to the service consumer by the service consumer's web browser. The modified fourth web page 170 displays contact information 172, providing the service consumer with an opportunity to update this information, if necessary, and to then input a mouse click to the “save and continue” feature 174. This mouse-click input initiates yet an additional information exchange between the service consumer's web browser and the automated system, resulting in further modification and display of the fourth web page to the service consumer. The further-modified fourth web page 176 is shown in FIG. 1K. The further-modified web page includes a text-entry feature 178 and photo-input features 179-181 that allow the service consumer to provide additional textural information and photographic information to the automated system in order to further describe the service consumer's project or projects. Once the additional information has been provided, the service consumer inputs a mouse click to the “finalize” input feature 182, resulting in a final exchange of information between the service consumer's web browser and the automated system. As a result of the final information exchanged, a further modified fourth web page is displayed by the service consumer's web browser to the service consumer. FIG. 1L shows the finally modified fourth web page 184. The finally modified fourth web page displays the selected appointment time 186 and additional confirmation information. At this point, the automated system has scheduled service provision by the selected service provider and contacted the service provider by email, telephone, text message, and/or other communications means to schedule the service provision with the service provider. Information about the scheduled appointment is maintained within the automated system for subsequent access both by the service consumer and the service provider.

### Overview of the Distributed-Automated-System Architecture

In many discussions of computer-system architecture, the term “abstraction” is used to described higher-level entities relative to lower-level entities. The term “abstraction” is not, in any way, intended to mean or suggest an abstract idea or concept. Computational abstractions are tangible, physical interfaces, modules, and subsystems that are implemented, ultimately, using physical computer hardware, data-storage devices, and communications systems. The term “abstraction” refers, in computational fields, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

There is a tendency among those unfamiliar with modern technology and science to misinterpret the terms “abstract” and “abstraction,” when these terms are used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

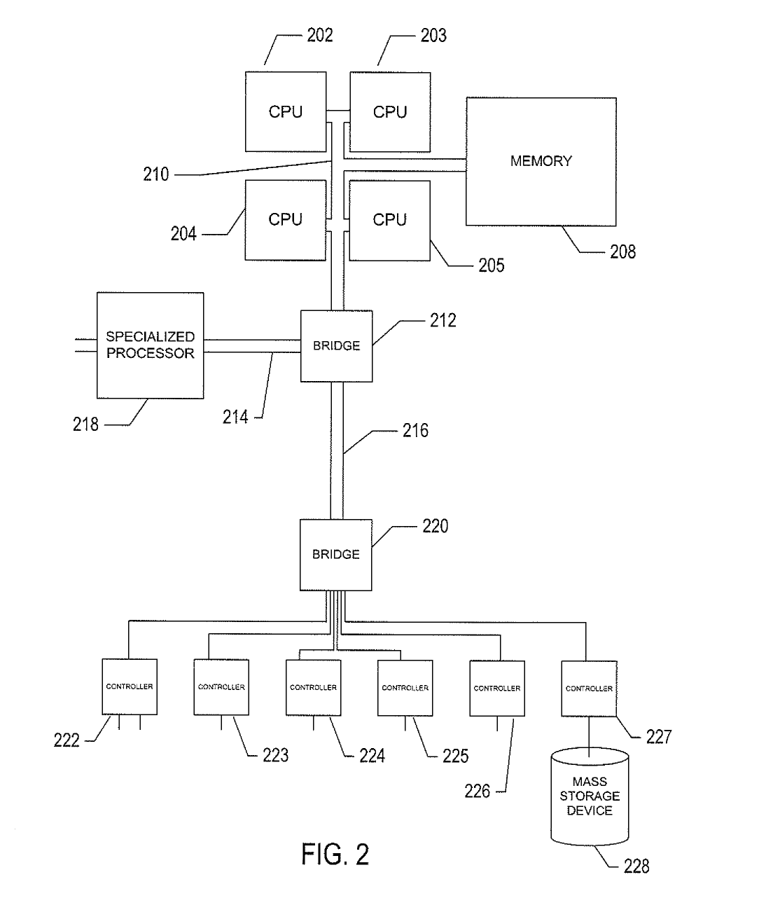

FIG. 2 provides a general architectural diagram for various types of computers. Computers within distributed systems that receive, process, and store data about service providers, service consumers, and services may be described by the general architectural diagram shown in FIG. 2, for example. The computer system contains one or multiple central processing units (“CPUs”) 202-205, one or more electronic memories 208 interconnected with the CPUs by a CPU/memory-subsystem bus 210 or multiple busses, a first bridge 212 that interconnects the CPU/memory-subsystem bus 210 with additional busses 214 and 216, or other types of high-speed interconnection media, including multiple, high-speed serial interconnects. These busses or serial interconnections, in turn, connect the CPUs and memory with specialized processors, such as a graphics processor 218, and with one or more additional bridges 220, which are interconnected with high-speed serial links or with multiple controllers 222-227, such as controller 227, that provide access to various different types of mass-storage devices 228, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

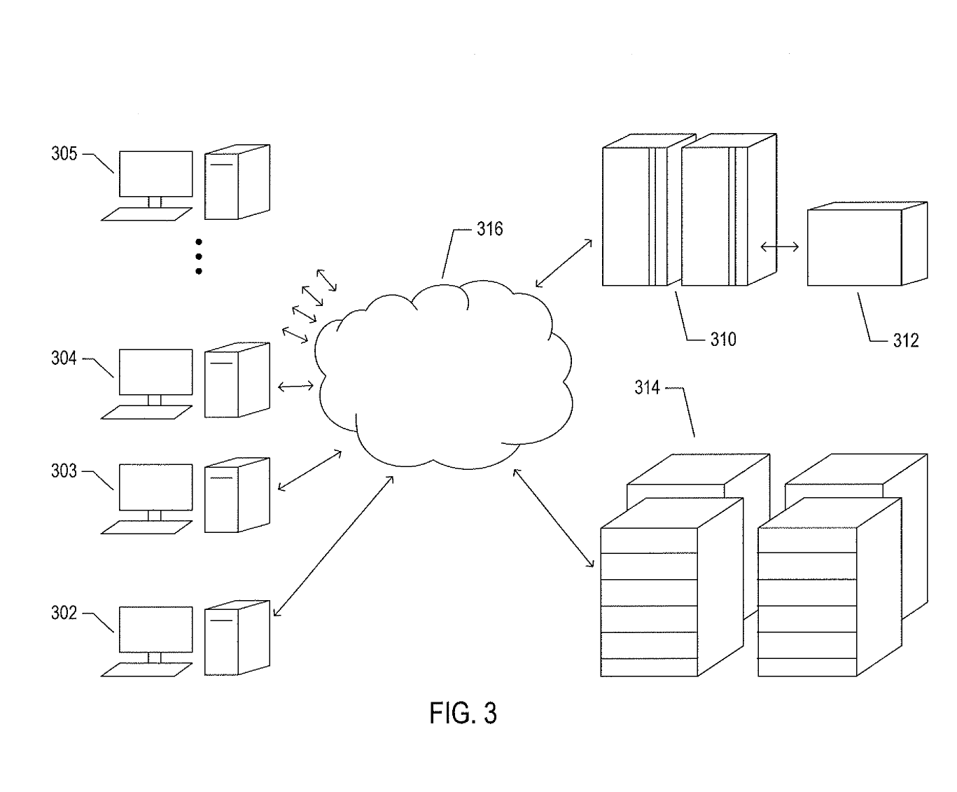

FIG. 3 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 3 shows a typical distributed system in which a large number of PCs 302-305, a high-end distributed mainframe system 310 with a large data-storage system 312, and a large computer center 314 with large numbers of rack-mounted servers interconnected through various communications and networking systems that together comprise the Internet 316. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

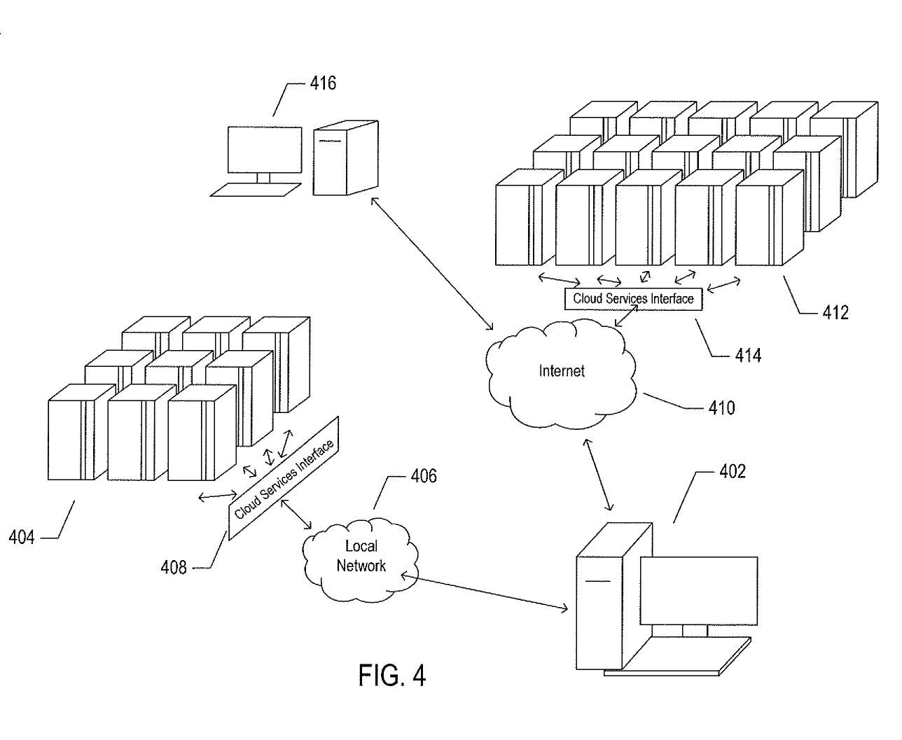

FIG. 4 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of subscribing to computing services provided by public cloud-computing service providers. In FIG. 4, a system administrator for an organization, using a PC 402, accesses the organization's private cloud 404 through a local network 406 and private-cloud interface 408 and also accesses, through the Internet 410, a public cloud 412 through a public-cloud services interface 414. The administrator can, in either the case of the private cloud 404 or public cloud 412, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 416.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

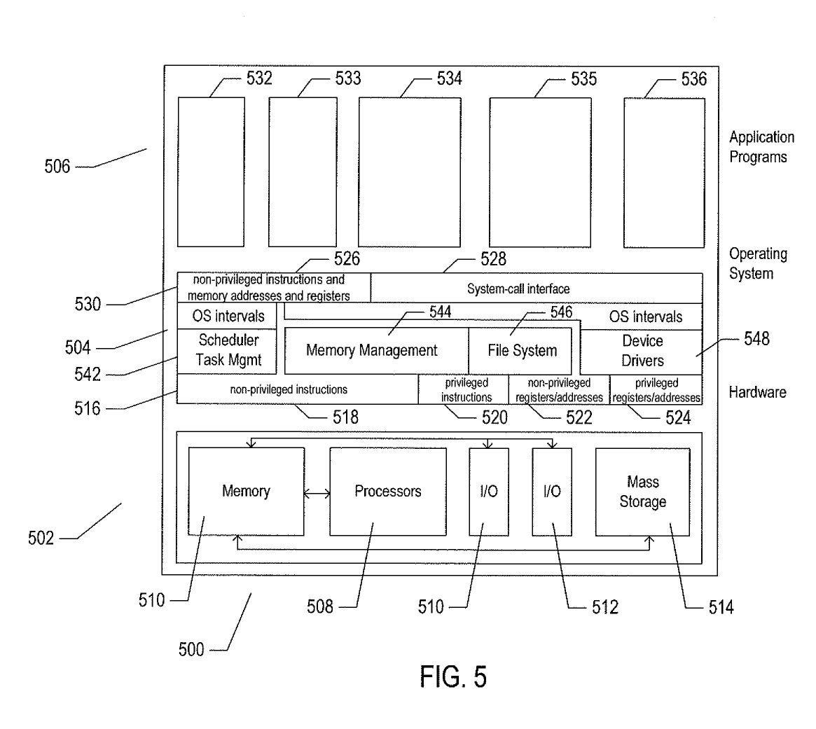

FIG. 5 illustrates generalized hardware and software components of a general-purpose computer system, such as a general-purpose computer system having an architecture similar to that shown in FIG. 5. The computer system 500 is often considered to include three fundamental layers: (1) a hardware layer or level 502; (2) an operating-system layer or level 504; and (3) an application-program layer or level 506. The hardware layer 502 includes one or more processors 508, system memory 510, various different types of input-output (“I/O”) devices 510 and 512, and mass-storage devices 514. Of course, the hardware level also includes many other components, including power supplies, internal communications links and busses, specialized integrated circuits, many different types of processor-controlled or microprocessor-controlled peripheral devices and controllers, and many other components. The operating system 504 interfaces to the hardware level 502 through a low-level operating system and hardware interface 516 generally comprising a set of non-privileged computer instructions 518, a set of privileged computer instructions 520, a set of non-privileged registers and memory addresses 522, and a set of privileged registers and memory addresses 524. In general, the operating system exposes non-privileged instructions, non-privileged registers, and non-privileged memory addresses 526 and a system-call interface 528 as an operating-system interface 530 to application programs 532-536 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 542, memory management 544, a file system 546, device drivers 548, and many other components and modules. To a certain degree, modern operating systems provide numerous levels of abstraction above the hardware level, including virtual memory, which provides to each application program and other computational entities a separate, large, linear memory-address space that is mapped by the Id operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 536 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

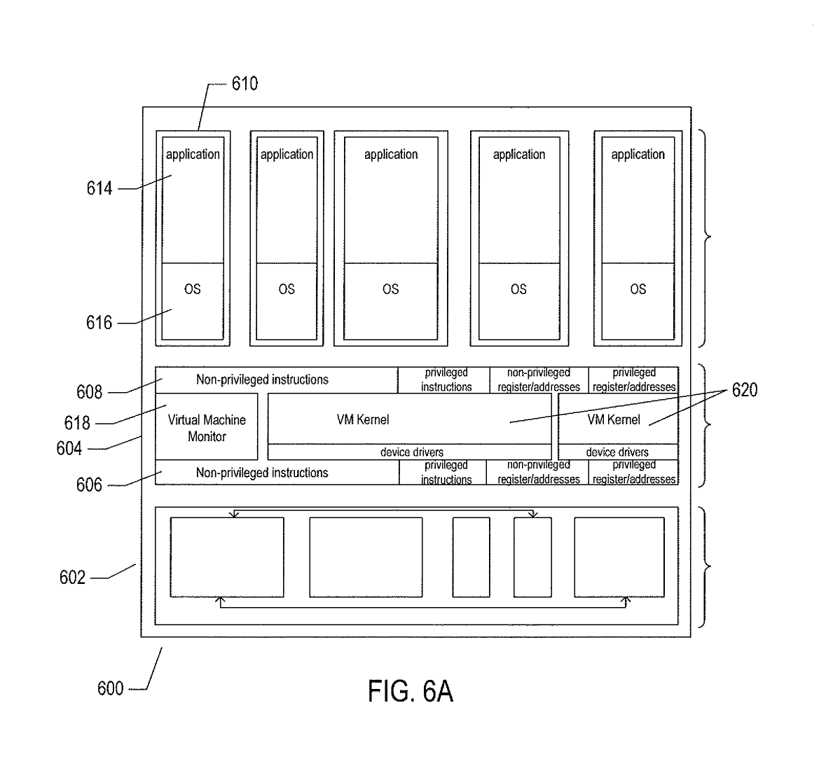

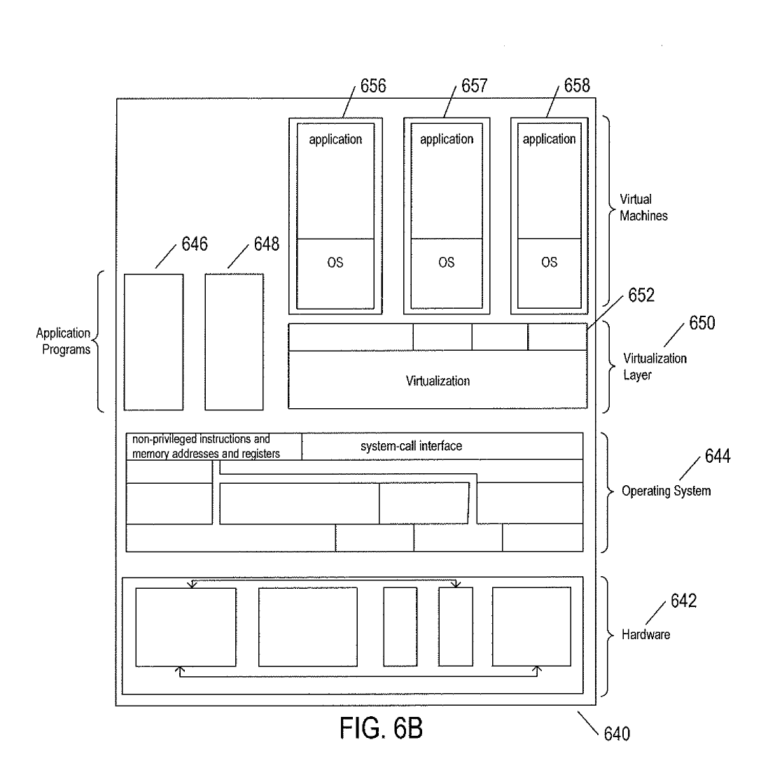

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 6A-B illustrate two types of virtual machine and virtual-machine execution environments. FIGS. 6A-B use the same illustration conventions as used in FIG. 5. FIG. 6A shows a first type of virtualization. The computer system 600 in FIG. 6A includes the same hardware layer 602 as the hardware layer 502 shown in FIG. 5. However, rather than providing an operating system layer directly above the hardware layer, as in FIG. 5, the virtualized computing environment illustrated in FIG. 6A features a virtualization layer 604 that interfaces through a virtualization-layer/hardware-layer interface 606, equivalent to interface 516 in FIG. 5, to the hardware. The virtualization layer provides a hardware-like interface 608 to a number of virtual machines, such as virtual machine 610, executing above the virtualization layer in a virtual-machine layer 612. Each virtual machine includes one or more application programs or other higher-level computational entities packaged together with an operating system, referred to as a “guest operating system,” such as application 614 and guest operating system 616 packaged together within virtual machine 610. Each virtual machine is thus equivalent to the operating-system layer 504 and application-program layer 506 in the general-purpose computer system shown in FIG. 5. Each guest operating system within a virtual machine interfaces to the virtualization-layer interface 608 rather than to the actual hardware interface 606. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 608 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 618 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 608, the accesses result in execution of virtualization-layer code to simulate or emulate the privileged resources. The virtualization layer additionally includes a kernel module 620 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 6B illustrates a second type of virtualization. In FIG. 6B, the computer system 640 includes the same hardware layer 642 and software layer 644 as the hardware layer 502 shown in FIG. 5. Several application programs 646 and 648 are shown running in the execution environment provided by the operating system. In addition, a virtualization layer 650 is also provided, in computer 640, but, unlike the virtualization layer 604 discussed with reference to FIG. 6A, virtualization layer 650 is layered above the operating system 644, referred to as the “host OS,” and uses the operating system interface to access operating-system-provided functionality as well as the hardware. The virtualization layer 650 comprises primarily a VMM and a hardware-like interface 652, similar to hardware-like interface 608 in FIG. 6A. The virtualization-layer/hardware-layer interface 652, equivalent to interface 516 in FIG. 5, provides an execution environment for a number of virtual machines 656-658, each including one or more application programs or other higher-level computational entities packaged together with a guest operating system.

In FIGS. 6A-B, the layers are somewhat simplified for clarity of illustration. For example, portions of the virtualization layer 650 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

Many implementations of the distributed service-provider-matching system, discussed in the following subsection, employ large numbers of virtual servers within virtual data centers provided by cloud-computing facilities. Other implementations may employ standalone servers and various types of private data centers. In all implementations, the distributed system consists of complex hardware platforms, various electronic user devices, and control components stored and executed within these hardware platforms and electronic user devices that, in part, comprise millions of electronically stored processor instructions.

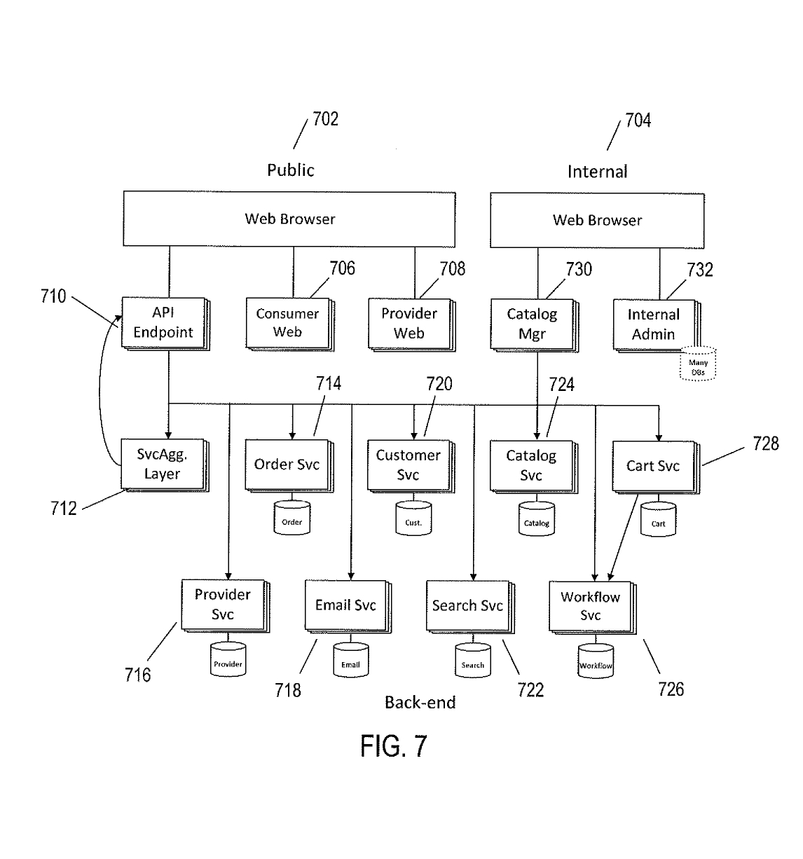

FIG. 7 illustrates the architecture of one implementation of the currently disclosed automated system that matches service providers with server-consumer projects. The architecture is illustrated in FIG. 7 as a block diagram. The automated system provides both a public interface 702 and an internal, private interface 704. The public interface is provided to remote web browsers by servers that run a consumer-web application 706 and servers that run a provider web application 708. In the currently described implementation, these servers, and additional servers running services, described below, reside in a distributed virtual data center provided by a cloud-computing-services organization.

The consumer-web application run by consumer-web servers 706 provides a web-page interface to service consumers that allow service consumers to create accounts, log into the automated system, create and edit project lists, obtain information about service providers matched to the project lists, select service providers, and schedule service provision by the selected service providers. An example web-page interface is discussed above with reference to FIGS. 1A-L.

The provider-web application, executed on multiple provider-web-application servers 708, provides a web-page interface to service providers. The service-provider web-page interface allows service providers to log into the automated system, create accounts, receive service-provision orders from service consumers, manage the orders, and carry out other interactions with the automated system. Both the consumer-web-application servers and provider-web-application servers access a large number of additional, internal servers and other computer systems that provide a number of services to the consumer-web-application servers and provider-web-application servers through API endpoint servers 710 that run an API-endpoint application. The API-endpoint-application servers 710 interact with aggregation-service servers 712, order-service servers 714, provider-service servers 716, email-service servers 718, customer-service servers 720, search-service servers 722, catalog-service servers 724, workflow-service servers 726, and cart-service servers 728 to provide complex services to the consumer-web-application servers and provider-web-application servers. The service-aggregation servers 712 run an aggregation service that aggregates data from other of the service servers to create complex data objects that are returned through the API-endpoint servers to requesting consumer-web-application servers and provider-web-application servers. The order service, implemented by the order-service servers 714, provides services related to recording and tracking orders made by service consumers as well as maintaining data regarding service providers' availability and schedules. The customer service provided by customer-service servers maintains service-consumer information, including name, contact information, address information, account information, credit information, and other service consumer information. The catalog service provided by the catalog-service server 724 maintains databases of SKUs, including price information, trade information, and skill information. The cart service provided by the cart-service servers 728 maintains project lists for service consumers as they are created and modified by service consumers prior to scheduling service provision. The provider service provided by the provider-service servers 716 maintains information about service providers, including name, years in business, contact information, and other such information. The match-processing functionality, discussed in detail in the following subsection, is executed by the provider-service servers. The email service provided by the email-service servers 718 maintains email-communications templates used for communicating with both service providers and service consumers. The search service provided by the search-service servers 722 maintains indexes of search terms that are mapped to SKUs maintained by the catalog service. The workflow service provided by the workflow-service servers 726 carries out offline processing of asynchronous workflows involved with order processing and system maintenance. The internal interface 704 includes an administrative web-page interface provided by catalog-manager-application servers 730 that allows employees of the organization that manages the automated system to modify information maintained and provided by the various service-providing servers. An additional internal-administration interface is provided by internal-administration servers 732.

In most implementations, there are multiple virtual servers of each type that are logically represented by a single endpoint. Load-balancing functionality is employed for distributing workload among the multiple servers of each service and interface. Internal communications, in many implementations, employ RESTful Representational state transfer protocols (“RESTful protocols”) based on JavaScript Object Notation (“JSON”) over the hypertext transfer protocol (“HTTP”). Each of the services is generally associated with stored information. In many implementations, the stored information is stored in various virtual mass-storage appliances for access by the service-providing services.

### Method and System for Matching Service Providers to Service Consumer Projects

In the current subsection, a detailed description of one implementation of the automated method for matching service providers to service consumer projects is provided with reference to descriptions of stored data, flow diagrams, and pseudo code. This information provides a detailed description of one implementation of the method for matching service providers to service consumer projects that is incorporated within implementations of the distributed automated system discussed in previous subsections.

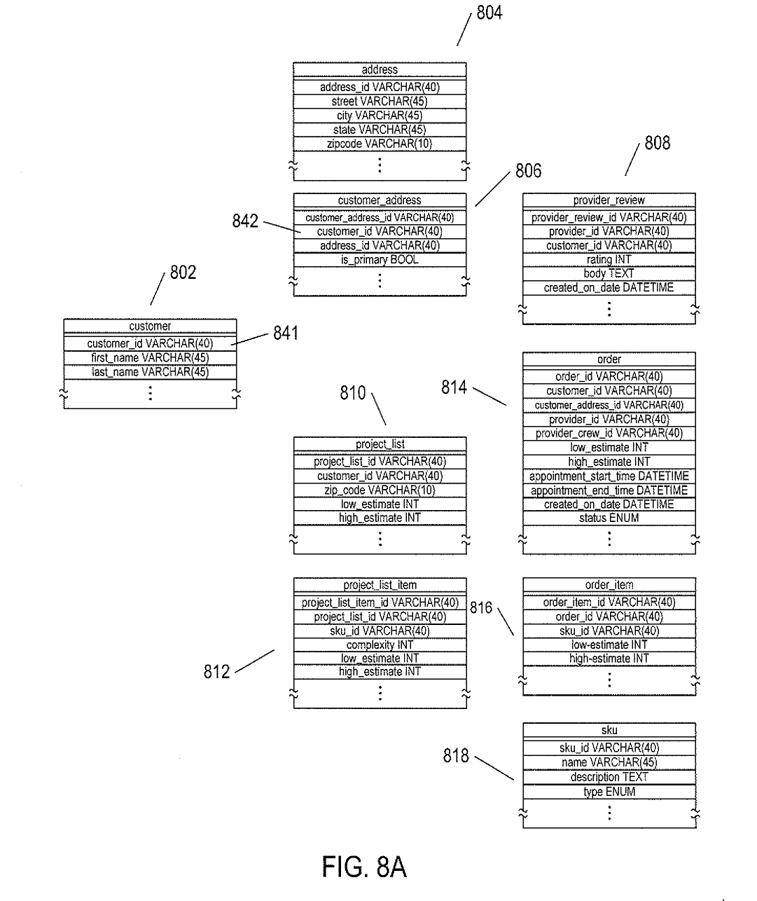

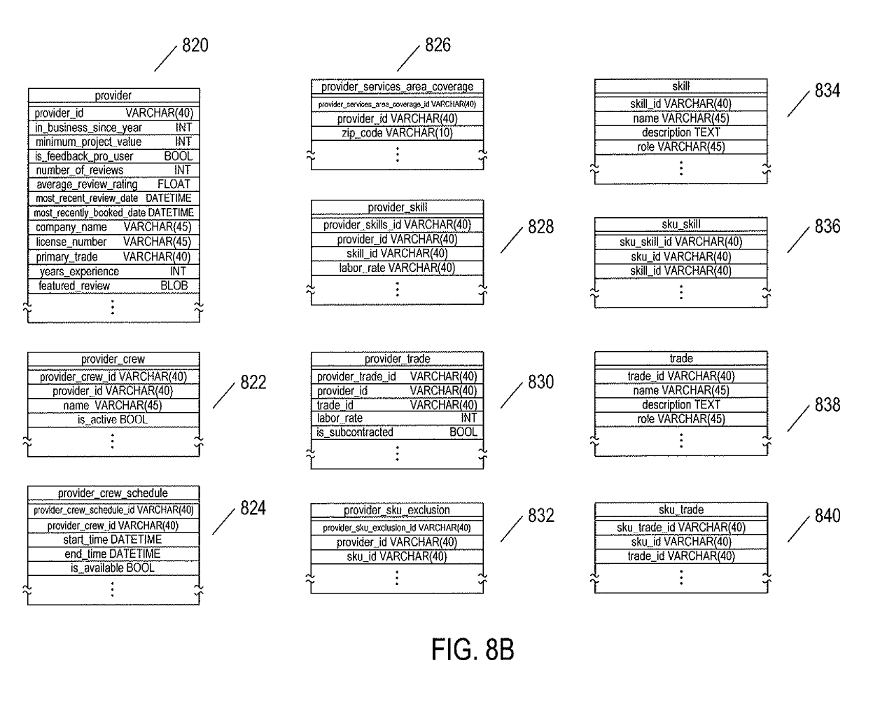

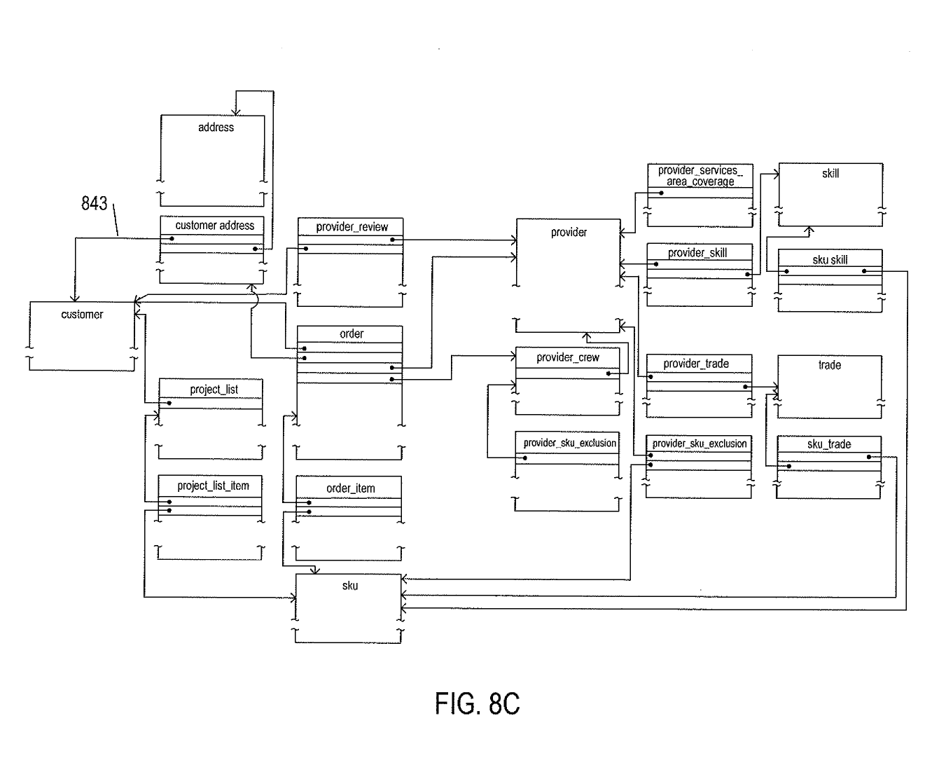

FIGS. 8A-C illustrate the types of data maintained within the automated system to provide for the service-consumer web interface that allows service consumers to create project lists and select service providers for carrying out projects from sets of candidate service providers matched to the project lists by the automated system. It should be emphasized that, in the distributed automated system, data may be distributed across multiple types of servers running different applications, with each server or type of server responsible for storing and managing only a portion of the aggregate data stored and managed by the distributed automated system. In the following discussion, the aggregate data is discussed as if it were stored in a single database or storage appliance. In certain implementations, this may be the case, but in many implementations, it is not the case. However, viewing the data as a whole, rather than as partitioned among server types, provides greater clarity and simplicity of description.

In FIGS. 8A-B, the stored data is organized into higher-level categories or data-object types. These higher-level categories include customer data 802, address data 804, customer-address data 806, provider-review data 808, project-list data 810, project-list-item data 812, order data 814, order-item data 816, and SKU data 818, as shown in FIG. 8A, and provider data 820, provider-crew data 822, provider-crew-schedule data 824, provider-services-area-coverage data 826, provider-skill data 828, provider-trade data 830, provider-SKU-exclusion data 832, skill data 834, SKU-skill data 836, trade data 838, and SKU-trade data 840, shown in FIG. 8B. Each of the data-object types shown in FIGS. 8A-B includes multiple fields, each field corresponding to a horizontal row or entry and including a field name and corresponding data type. The automated system generally stores many different data objects of each type. A data object is an instantiation of a data-object type, and includes specific values for each of the fields. A data-object type is a template or pattern for instantiating data objects of the data-object type.

Each data-object type includes a data-object-identifier field, the identifier within which uniquely identifies each data object instantiated from each data-object type shown in FIGS. 8A-B. For example, each customer, or service consumer, for which customer information is stored within the automated system is TO identified by a customer identifier, shown in FIG. 8A as the customer id entry 841 in the customer data object 802. The customer id entry, or field, has the data type “VARCHAR(40).” This data type is a variable length character string with a maximum size of 40 characters.

Many of the data-object types illustrated in FIGS. 8A-B include fields that contain identifiers, or keys, for linking data objects instantiated from these data-object types to other data objects. For example, a customer-address data object instantiated from the customer-address data-object type 806 includes a field 842 that contains the customer identifier of a customer data object that describes a customer whose address is represented by a customer-address data object. FIG. 8C illustrates links between data-object types. For example, the link from a customer-address data object to a customer data object is represented by arrow 843 in FIG. 8C.

In general, there are many objects of each data-object type stored in the automated system. For example, each service consumer is represented by a customer data object of the customer data-object type 802. Similarly, each service provider associated with the automated system is represented by a provider data object of the provider data-object type 820. A particular address may be used by multiple customers, as a result of which each customer-address data object references an address data object of the address data-object type 804, to avoid storage of redundant address information. Each customer project list is represented by a data object of the project-list data-object type 810. Projects within the list are represented by data objects of the project-list-item data-object type 812. Reviews of services provided for service providers by service consumers are represented by data objects of the provider-review data-object type 808. Orders for services, or scheduled appointments, are represented by data objects of the order data-object type 814. Individual scheduled tasks that together comprise an order are each represented by data objects of the order-item data-object type 816. The SKUs corresponding to various different types of services performed by the service providers associated with the automated system are each represented by an SKU data object of the SKU data-object type 818. Each member of a provider's crew is represented by a data object of the provider-crew data-object type 822. Each appointment time associated with a provider crew member is represented by a data object of the provider-crew-schedule data-object type 824. The service areas associated with a provider are each represented by a data object of the provider-services-area-coverage data-object type 826. Skills associated with a provider are each represented by a data object of provider-skill data-object type 828. Each trade associated with a provider is represented by a data object of the provider-trade data-object type 830. The SKUs describing services that cannot be performed by a provider are represented by data objects of the provider-SKU-exclusion data-object type 832. Skills are represented by data objects of the skill data-object type 834. Data objects of the SKU-skill data-object type 836 provide for association of provider-skill data objects with skill data objects. Each trade is represented by a data object of the trade data-object type 838. SKU-trade data objects of the SKU-trade data-object type 840 associate trade data objects with SKU data objects.

The names of the fields or entries within the data-object types shown in FIGS. 8A-B are largely self-descriptive. Particular field types used in the matching method are discussed below. As also discussed, below, the data-object types shown in FIGS. 8A-B may be implemented in a variety of different ways, including as instantiations of data-object classes stored within an object-oriented database, as relational-database tables, in flat-file-based data storage, and by many other types of data-storage systems.

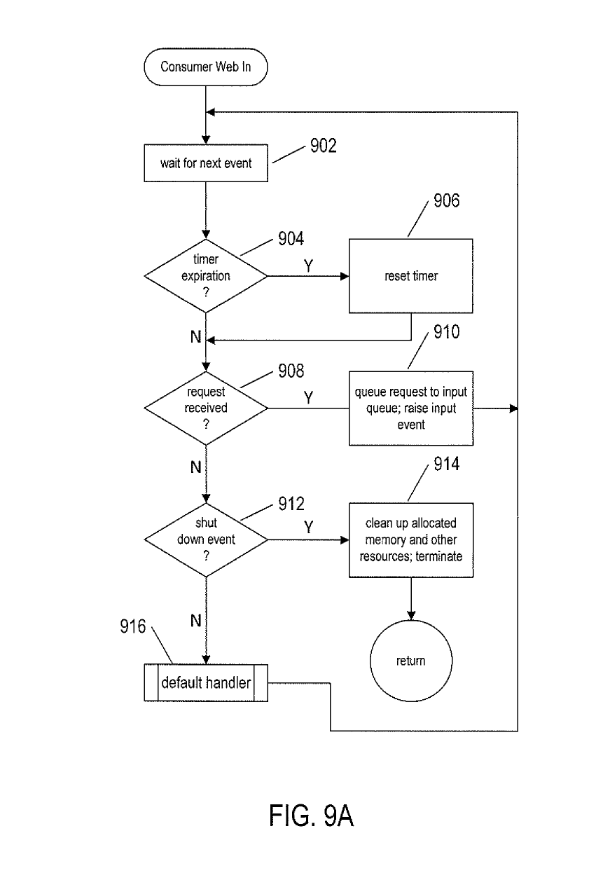

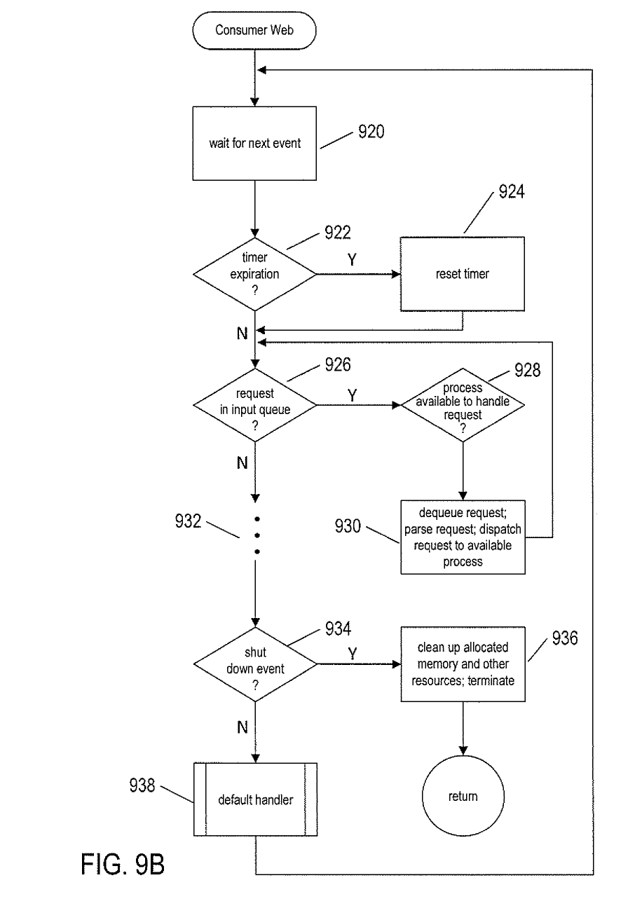

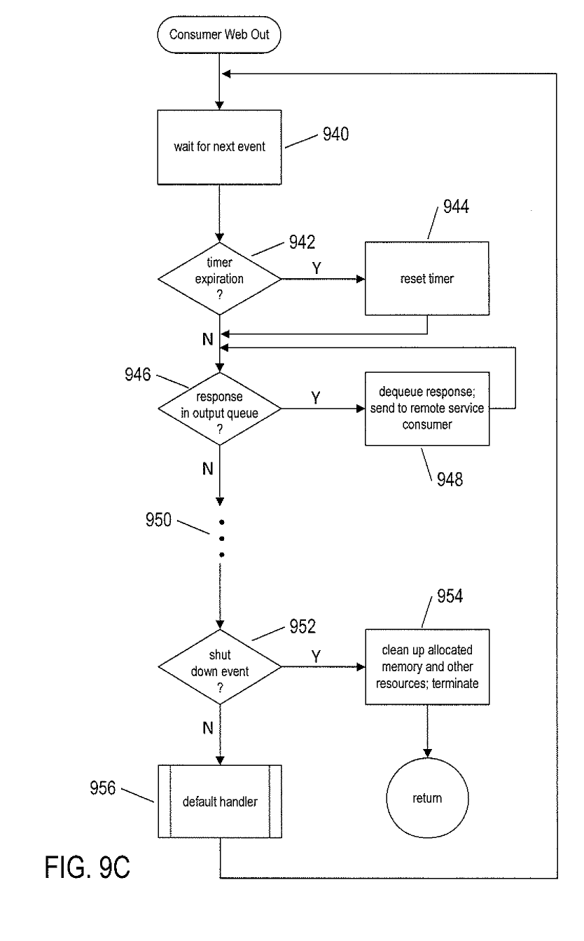

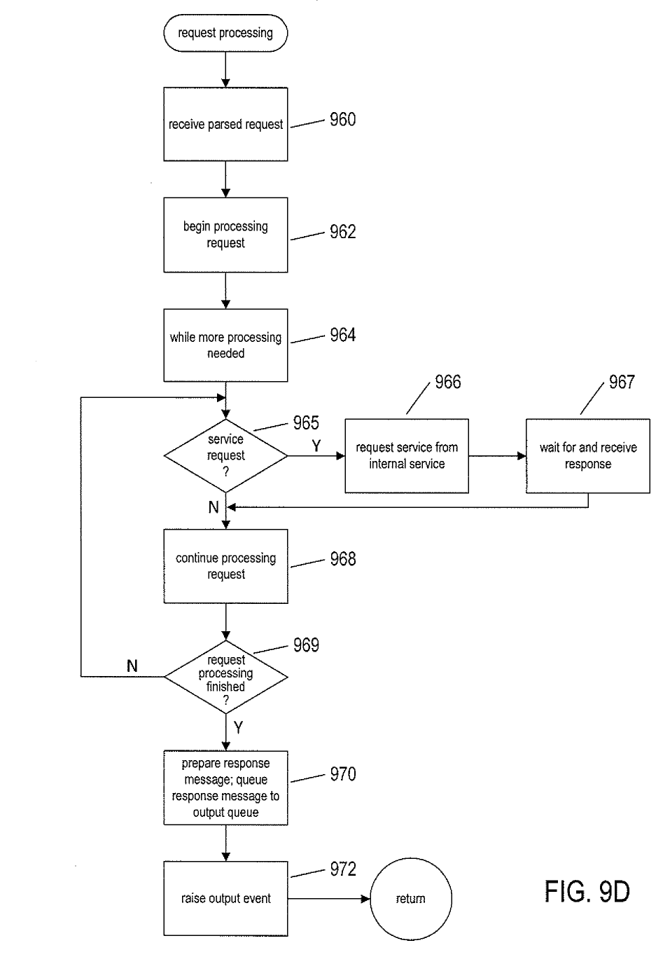

FIGS. 9A-D include control-flow diagrams that illustrate operation of the consumer-web-application servers (706 in FIG. 7). FIG. 9A shows a control-flow diagram for a routine “Consumer Web In.” This routine represents an asynchronous server process that listens to operating-system-provided communications ports for incoming messages. This asynchronous process operates as a continuous loop. The process waits, in step 902, for a next event. When a next event occurs, the process undertakes various event-determination steps to determine what type of event has occurred. In step 904, the process determines whether or not the recently occurring event is a timer expiration. If so, then, in step 906, the process resets the timer. A timer is used to periodically awaken the process to make sure that incoming messages are handled in a timely fashion, despite any failures in the incoming-message wakeup and/or interrupt mechanisms. When a new request has been received by the server, as determined in step 908, the process queues the request to an input queue and raises an input event, in step 910. Otherwise, when a shutdown event has occurred, as, for example, when the consumer-web application is terminated or the virtual server virtually or physically powered down, as determined in step 912, the process cleans up any allocated memory and other allocated resources and terminates, in step 914. Other types of events are handled by a default handler 916.

FIG. 9B provides a control-flow diagram for the main loop of the consumer-web application run by the consumer-web-application servers. In step 920, this main loop waits for the occurrence of a next event. As with the process described with reference to FIG. 9A, when the next-occurring event is a timer expiration, as determined in step 922, then the timer is reset in step 924. The timer is used to periodically awaken the main loop in case the occurrence of input events fail to awaken the process. When there is a new request queued to the input queue, as determined instep 926, and when there is an available process to handle the request represented by the queued request, as determined in step 928, then, in step 930, the consumer-web process dequeues the request from the input queue, parses the request, and dispatches the request to a suitable available process. Ellipsis 932 indicates that other types of events may be handled by the consumer-web-application main loop. When a shutdown event has occurred, as determined in step 934, the consumer-web-application process cleans up any allocated memory into other allocated resources and then terminates, in step 936. A default handler 938 handles other types of events.

FIG. 9C provides a control-flow diagram for a routine “Consumer Web Out” that represents an asynchronous process within the consumer-web-application server for returning responses to remote service consumers. As with the main-loop process described with reference to FIG. 9B and the incoming-request-handling process discussed with reference to FIG. 9A, above, the response-transmitting process operates as an endless loop. In step 940, the response-transmitting process waits for the occurrence of a next event. When the next-occurring event is a timer expiration, as determined in step 942, then the timer is reset in step 944. When there is a response in the output queue, as determined in step 946, the process dequeues the response and transmits the response, through an operating-system interface to a communications subsystem, to a remote service consumer, in step 948. Ellipsis 950 indicates that other types of events may be handled by the response-transmitting process. In the case that the next-occurring event is a shutdown event, as determined in step 952, the process cleans up any allocated memory and other resources and terminates, in step 954. Other types of events may be handled by a default handler 956.

FIG. 9D provides a control-flow diagram for a request-processing process to which requests are dispatched by the consumer-web-application server main loop, discussed above with reference to FIG. 9B. In step 960, the request-processing process receives a parsed request. In step 962, the request-processing process begins processing the request. In the while-loop of steps 964-969, entered when request processing needs to make a call to one of the many service providers, as detected in step 965, the request-processing process requests a service from an internal service-providing server, in step 966, and waits to receive a response to the request in step 967. Once a response has been received, the request-processing process continues processing the received request in step 968. When request processing has finished, as determined in step 969, then the request-processing process prepares a response message and queues the response message to the output queue in step 970. Otherwise, when as additional service call is needed, the while-loop iterates again. Finally, in step 972, the request-processing process raises an output event.

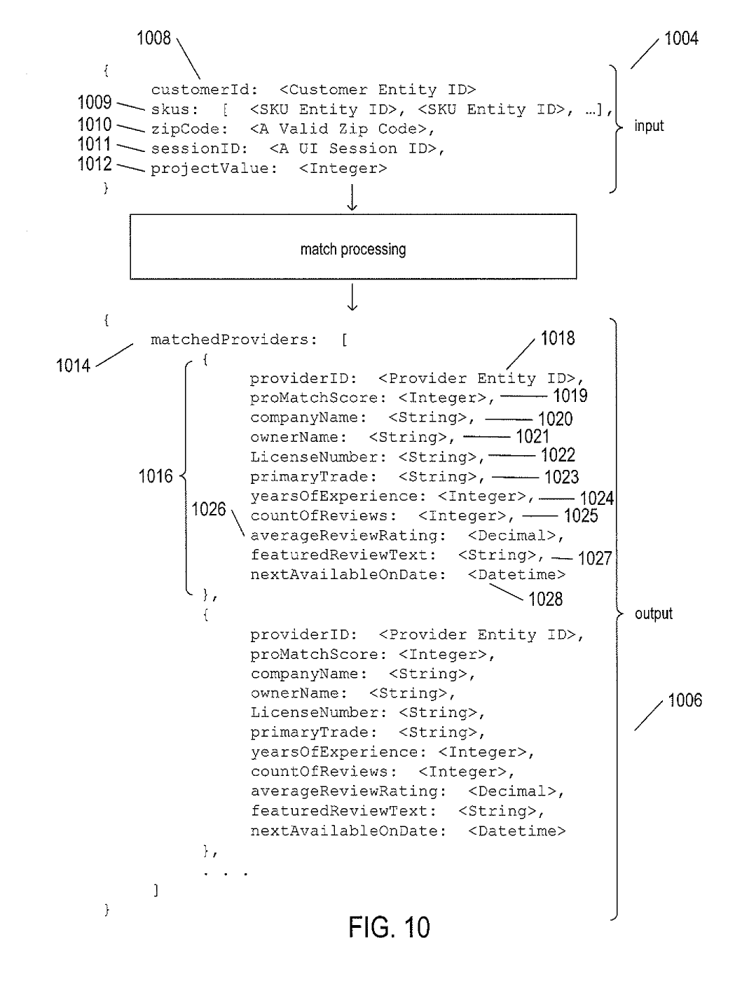

Next, the specific request processing that is carried out when, as discussed above with reference to FIG. 1F, a service consumer inputs a mouse click to the “find a pro” button 142, is discussed with reference to pseudocode and flow diagrams. The main activity in request processing for the information-exchange transaction initiated by service-consumer input to the “find a pro” feature 142 is a match-processing process in which information, collected and temporarily stored on behalf of the service consumer during previous transactions described above with reference to FIGS. 1A-E, is used to identify an ordered set of candidate service providers who can undertake and complete the projects in the service-consumer's project list. FIG. 10 illustrates a match-processing routine that represents the service-provider matching process carried out by the automated system. The match-processing process is represented by the rectangular block 1002. Input to the match-processing process is shown in pseudocode block 1004. Output from the match-processing process is shown in pseudocode block 1006. The input to the match-processing process, in one implementation, includes a customer identifier 1008, a list of SKUs corresponding to projects in the service consumer's project list 1009, a zip code for the location in which the service or services are to be performed 1010, a session ID 1011 that identifies the current session context, each session corresponding to a series of information-exchange transaction carried out between the service consumer and automated system, and an estimated project cost, or project value 1012. The match-processing process 1002 uses the input information to identify a set of appropriate candidate service providers. In FIG. 10, the set of candidate providers is shown, in pseudocode, as the list “matchedProviders” 1014, each provider in the list represented by a block of values, such as the block of values 1016 that represent a first candidate provider. The list is sorted in descending order based on a match score computed for each candidate provider by the automated system. Computation of the match score is discussed in great detail, below. Each candidate service provider is described by a provider identifier 1018, the match score 1019, a company name 1020, an owner name 1021, a license number 1022, an indication of the provider's primary trade 1023, a number of years of experience 1024, the number of reviews submitted by service consumers for the provider 1025, an average review rating 1026, a text block containing portions of one of the service-consumer's reviews 1027, and an indication of the provider's next available appointment time 1028.

Of course, the input information and output information may vary from implementation to implementation, depending on the types of data stored within the automated system to describe service-consumer requests and service providers, the particular web-page interface accessed by service consumers, the types of services being requested by a service consumer, the category of service consumers to which the service consumer belongs, geographical location, state and country in which the service is being contracted and in which the service is to be performed, business and legal conditions and considerations, and on many other factors and parameters. FIG. 10 illustrates one particular implementation of a routine that encodes functionality of the match-processing process.

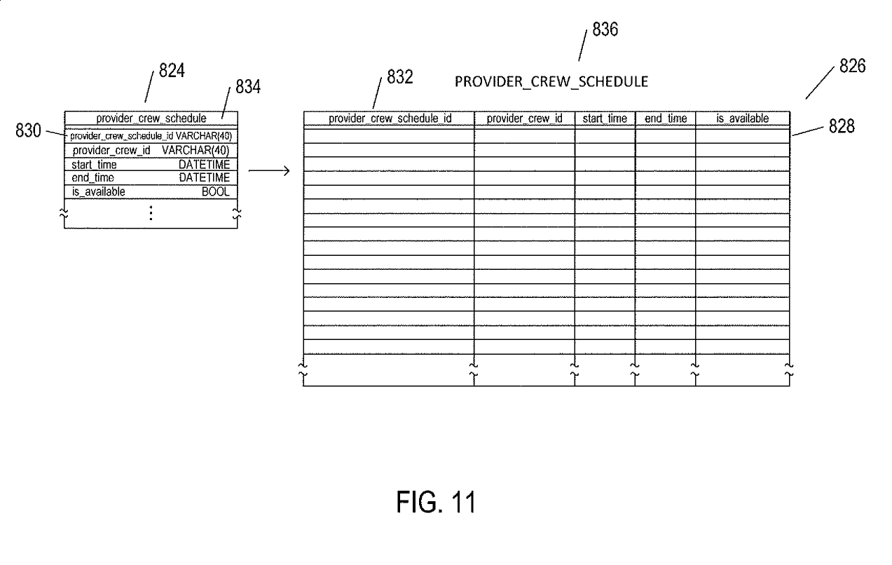

In the following discussion, a relational database is assumed to be used by the automated system to store the many data objects of the data-object types illustrated in FIGS. 8A-C. FIG. 11 illustrates the relational-database perspective on data storage. In FIG. 11, the provider-crew-schedule data-object type 824, initially shown in, and described with reference to, FIG. 8B is illustrated as being transformed into a relational-database table 826. Each row in the relational database table, such as row 828, represents an instance of a data object of the data-object type represented by the provider-crew-schedule data-object type 824. Each column in the relational-database table 826 represents a field or entry of the provider-crew-schedule database-object type. For example, the provider-crew-schedule-id field 830 is represented by the first column 832 in the relational database table. The columns are associated with the data types corresponding to the fields in the provider-crew-schedule database-object type. For example, the provider-crew-schedule-id column 832 includes entries of type “VARCHAR(40).” Lower-case data-object names, such as “provider_crew_schedule” 834 are transformed to uppercase relational-database names 836. The column names of the relational-database table 826 are identical to the field names and the database-object type. A relational-database is assumed in order to use the structured query language (“SQL”) and embedded SQL to illustrate various data-related operations.

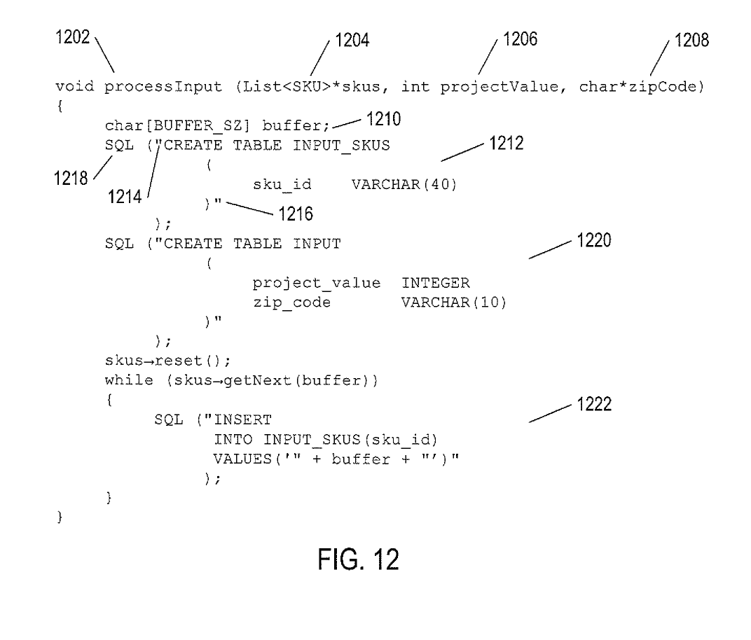

FIG. 12 shows a pseudocode implementation of a routine “processInput” that processes certain of the input data (1004 in FIG. 10) that is input to the match-processing process (1002 in FIG. 10). In particular, the routine “processInput” processes the list of SKUs 1204, the project value 1206, and the zip code 1208 supplied as input items 1009, 1012, and 1010 in FIG. 10. A local variable “buffer” 1210 is used to store SKU identifiers extracted from the list of SKUs 1204. The routine “processInput” 1202 uses embedded SQL to carry out relational-database operations. SQL statements, such as the CREATE TABLE statement 1212, are included as character strings within quotes, such as quotes 1214 and 1216, and supplied as arguments to the SQL-execution procedure “SQL” 1218. This routine is assumed to return the first of any data items produced by execution of the SQL statement. In many cases, the returned values are ignored. The first embedded SQL statement creates a temporary relational-database table “INPUT_SKUS.” A second embedded SQL statement 1220 creates a temporary relational-database table “INPUT.” The temporary relational-database table “INPUT_SKUS” includes a single column sku_id that contains SKU identifiers extracted from the list of SKUs 1204. The temporary relational-database table “INPUT” includes two columns, and a single row, to store the input project value 1206 and the input zip code 1208. Finally, in a while-loop 1222, each SKU identifier extracted from the input list of SKUs 1204 is inserted into the temporary relational-database table “INPUT_SKUS.” The temporary tables “INPUT_SKUS” and “INPUT” provide a means for introducing input values into relational-database tables that can be subsequently manipulated by embedded SQL statements in the matching routine.

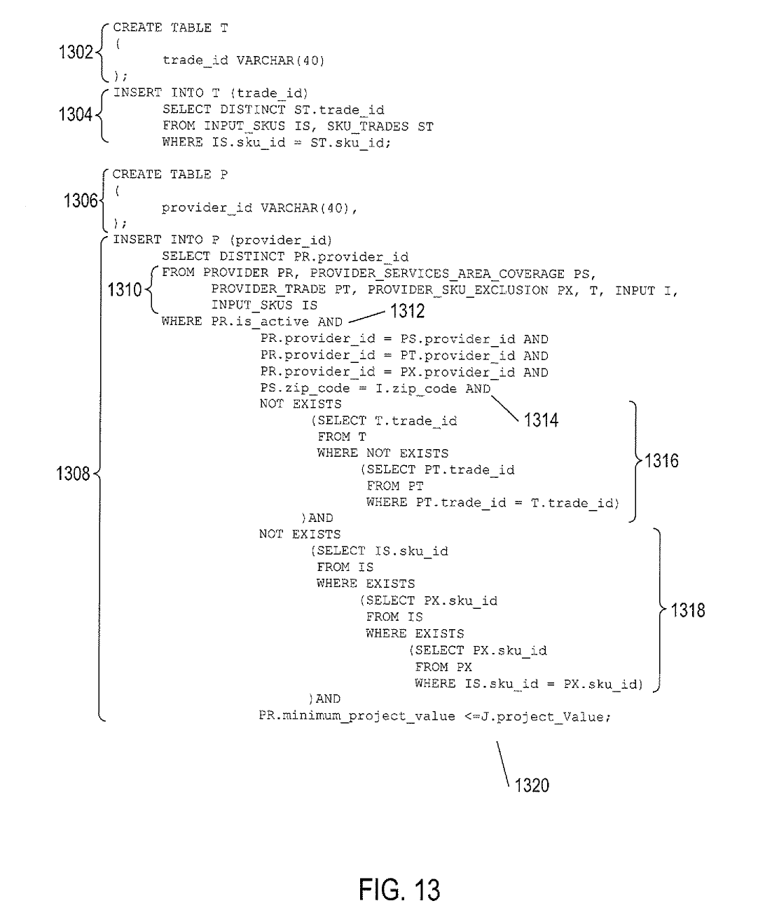

FIG. 13 shows four SQL commands that carry out initial selection of providers from the relational database that contains the relational-database tables discussed above with reference to FIGS. 8A-C and FIG. 11. A first SQL command 1302 creates a temporary table “T” to store trade identifiers. A second SQL command 1304 inserts trade identifiers into the temporary table “T.” The trade identifiers are those trade identifiers that are associated, by entries in the relational-database table SKU_TRADES, to the input SKUs stored in the temporary relational-database table “INPUT_SKUS” and with entries in the SKU_TRADES relational database table. The trade identifiers inserted into temporary table “T” are therefore the trade identifiers corresponding to the items in a service consumer's project list. A third SQL command 1306 creates an additional relational-database temporary table “P” for storing provider identifiers for candidate providers.

A fourth SQL command 1308 selects identifiers corresponding to providers as identifiers for candidate providers and inserts them into the temporary relational-database table “P.” Selection of the candidate providers is carried out by a multi-way join 1310 of the tables PROVIDER, PROVIDER_SERVICES_AREA_COVERAGE, PROVIDER_TRADE, PROVIDER_SKU_EXCLUSION, T, INPUT, and INPUT_SKUS. The initial candidate providers are providers who are currently active 1312, who provide services in areas with the same zip code as the zip code associated with the service request made by the service consumer 1314, who have listed, as trades that they are qualified to work in, all of the trades associated with the input SKUs 1316, who have not listed, as SKU exclusions, any of the SKUs in the input SKU list 1318, and who have a minimum project value or minimum charge less than or equal to the estimated project value for the requested service 1320. The final SQL command 1308 identifies all of the service providers for which data is stored in the automated system that meet these criteria and place their provider identifiers into the temporary relational-database table “P.”

The SQL commands shown in FIG. 13 may be executed as embedded SQL commands from a procedural-language program, as are the SQL commands included in the routine “processInput” discussed above with reference to FIG. 12. Again, there are many different ways to store data in computer systems and many different procedural and non-procedural methods for extracting desired data. The SQL commands shown in FIG. 13 are one example of a portion of an implementation of an automated method for collecting provider identifiers for an initial set of candidate providers.

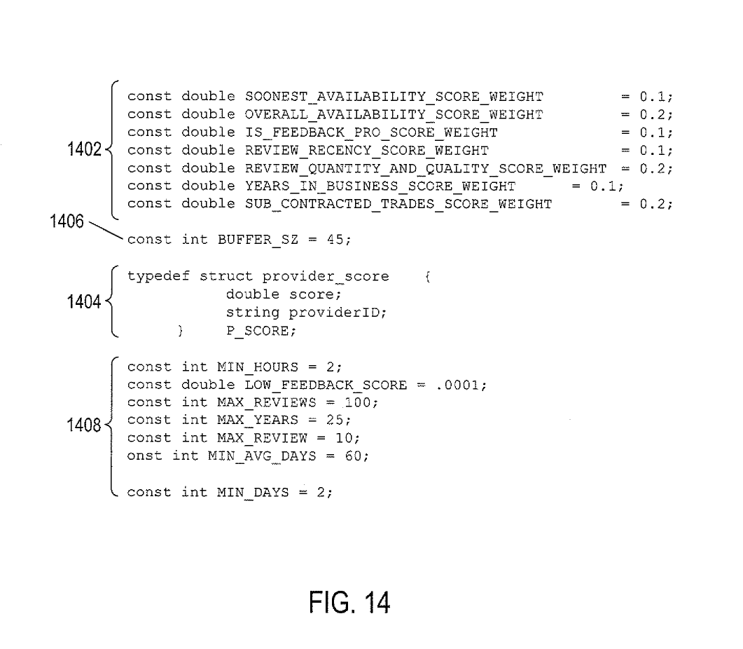

FIG. 14 shows a number of pseudocode constant declarations and a type declaration used in subsequent pseudocode descriptions of the remaining portion of the provider-matching process. A first set of constants 1402 represent weights that are used to multiply component scores in order to produce a final match score for each candidate provider. These weights are associated with particular considerations and characteristics of providers that are evaluated to produce the matching score. These considerations include the provider's next appointment slot, the overall availability of the provider to provide services, whether or not the provider uses the service consumer feedback facilities provided by the automated system, how recently the most recent review was provided by a service consumer for the provider, the quantity and quality of reviews provided by service consumers for the provider, the number of years that the provider has been in business, and the portion of trades associated with project SKUs that the provider subcontracts out to other service providers. A type declaration 1404 for a structure “provider_score” is used to associate matching scores with provider identifiers for local in-memory storage of scored candidate providers. Additional constants define a buffer size 1406 and various minimum and maximum values used for computing component scores 1408.

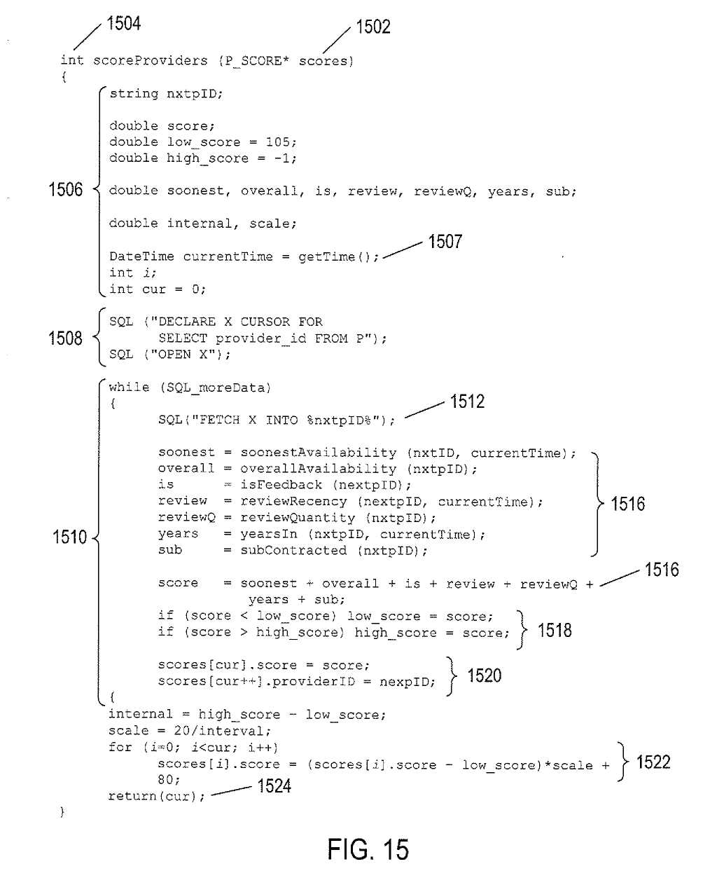

FIG. 15 provides pseudocode for a routine “scoreProviders” that computes scores for the initial set of candidate providers. The routine “scoreProviders” receives a pointer to a buffer for storing provider_score structures for each of the candidate providers 1502 and returns an integer value 1504 indicating the number of candidate providers for which scores have been placed into the buffer “scores” 1502. The routine “scoreProviders” initially includes a number of local-variable declarations 1506. Two embedded SQL statements 1508 are executed to select the provider identifiers from the temporary relational-database table “P” and to open a cursor used to retrieve one provider identifier at a time in a subsequent while-loop 1510. The while-loop 1510 processes each provider identifier extracted from the temporary relational-database table “P.” One of the local variables, “currentTime,” is set to the current time by a call to an operating system current-time function 1507. The embedded SQL command 1512 is used to place a next provider identifier into the local variable “nxtpID.” Then, in the block of pseudocode 1514, seven component scores are computed by calls to component-score-computing routines and placed in the local variables “soonest,” “overall,” “is,” “review,” “review queue,” “years,” and “sub.” The component scores are related to the soonest available appointment, the overall availability of the service provider, whether or not the service provider uses the feedback facilities within the automated system, how recently the most recent review was received for the provider, the overall quality and quantity of reviews provided by service consumers for the provider, the years that the provider has been in business, and the portion of trades associated with the service consumer's project list that are subcontract by the provider. Next, an overall score is computed 1516 for the service provider by adding the component scores computed in the pseudocode block 1516. The local variables “low_score” and “high_score” are used to identify the lowest and highest score produced for any of the candidate service providers 1518. In the last two lines of the while-loop 1520, the computed score and provider identifier for the currently considered provider are entered into a provider-score structure within the input buffer “scores.” When scores have been computed and stored for all of the providers in the while-loop 1510, a final for-loop 1522 is executed to scale all the scores to a range of 80 to 100. The number of provider_score structures stored in the input buffer is returned on line 1524.

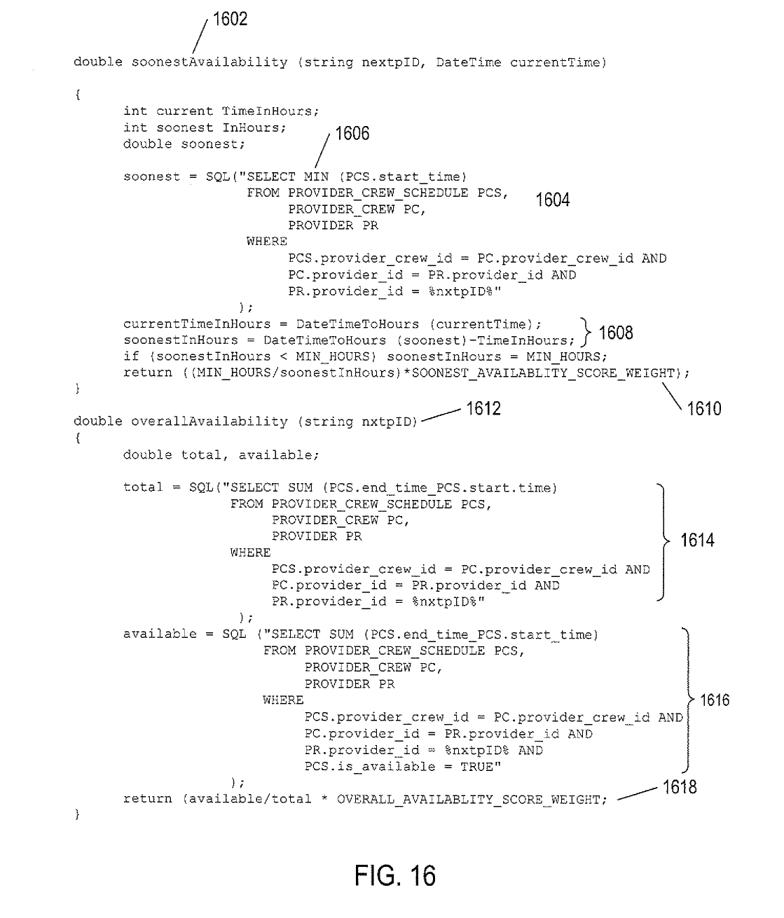

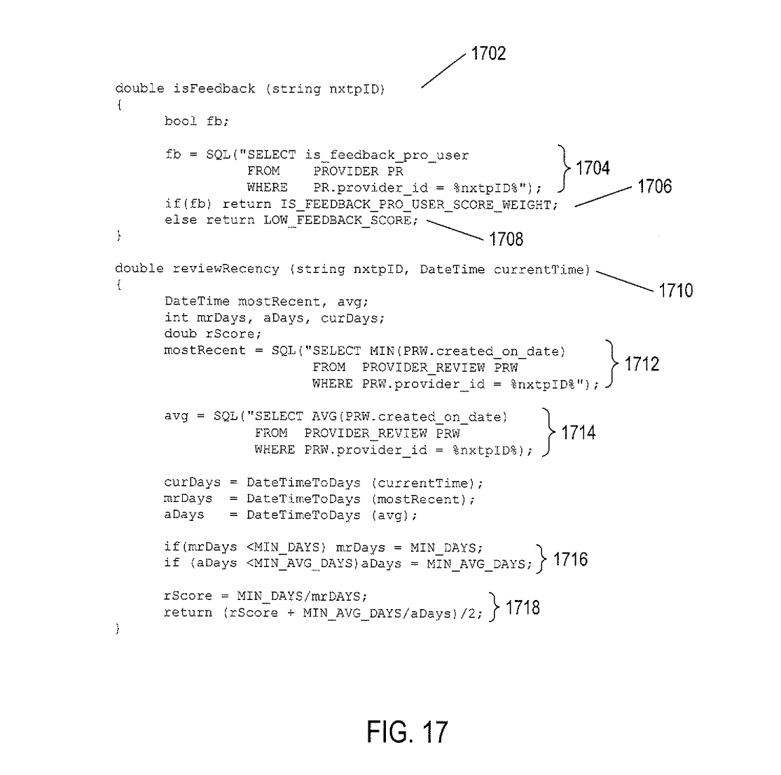

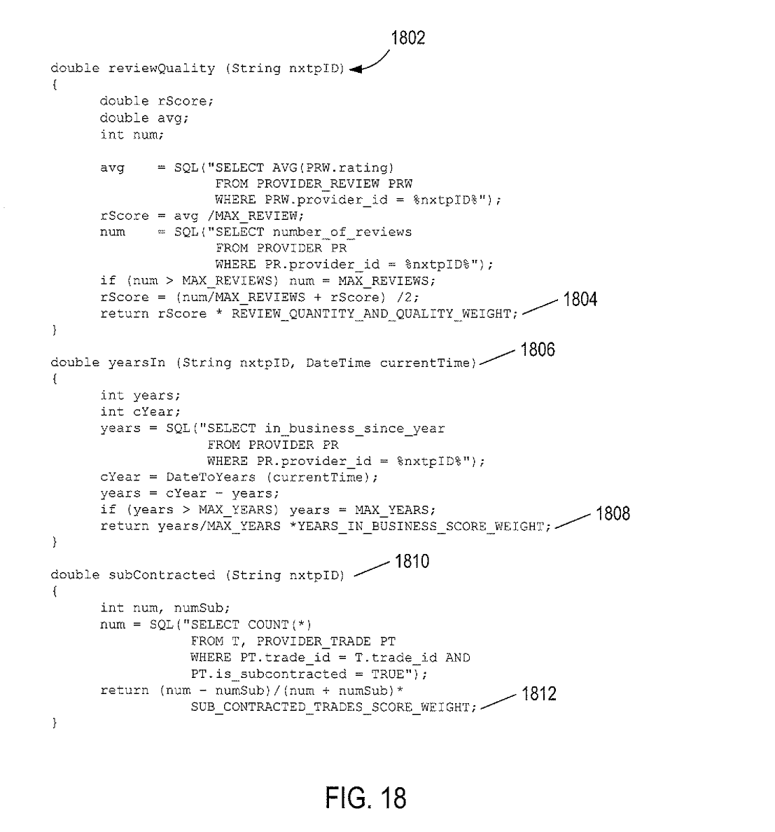

FIGS. 16-18 provide pseudocode implementations of the seven routines, called in the pseudocode block 1516 shown in FIG. 15 of the routine “scoreProviders,” that compute component scores subsequently added together to form the match score for a service provider. Each of these routines uses embedded SQL commands to obtain the information from the relational database needed to compute the component score. The routine “soonestAvailability” 1602 computes a first appointment time for a member of the provider's crew using a join over the relational-database tables PROVIDER_CREW_SCHEDULE, PROVIDER_CREW, and PROVIDER 1604. The pseudo implementation uses an SQL function “MIN” sufficiently intelligent to determine the minimum start time from entries with data type “DateTime” 1606. The soonest appointment time and current time are converted into hours and the current time is subtracted from the soonest appointment time to produce the number of hours until the soonest appointment time, stored in the variable “soonestInHours” in lines 1608. When the number of hours to the soonest appointment time is less than the constant MIN_HOURS, then the variable “soonestInHours” is set to MIN_HOURS. In the final line 1610, a component score is computed as MIN_HOURS divided by “soonestInHours” and then multiplied by the weight factor SOONEST_AVAILABLITY_SCORE_WEIGHT.

The routine “overallAvailability” 1612 computes a component score for the overall availability of the provider based on the schedule of appointment times for the provider. A first embedded SQL command is used to compute the total schedule time for the provider 1614, which is placed in the local variable “total.” A second embedded SQL command 1616 is employed to compute the total amount of appointment time that is currently available for scheduling, with the available appointment time placed into the local variable “available.” The component score is then computed, on line 1618, by dividing the value in the local variable “available” by the value in local variable “total” and then multiplying by the weighting factor OVERALL_AVAILABILITY_SCORE_WEIGHT. Note that it is assumed that the value stored in local variable “total” is non-zero.

The routine “isFeedback” 1702 determines, using the embedded SQL statement 1704, whether a provider uses feedback facilities of the automated system. If so, then the component score returned by the routine “isFeedback” is the weighting factor IS_FEEDBACK_PRO_USER_SCORE_WEIGHT, on line 1706. Otherwise, a very small value represented by the constant LOW_FEEDBACK_SCORE is returned on line 1708.

The routine “reviewRecency” 1710 computes a component score related to how recently a review was provided for the service provider by a service consumer to the automated system. A first embedded SQL command 1712 determines the date of the most recent review and a second SQL command 1714 determines the average creation date for reviews submitted for the service provider. These values are converted to days and adjusted to have minimum values MIN_DAYS and MIN_AVG_DAYS, respectively, on lines 1716. A component score is computed as the average of the ratios of the constant MIN_DAYS to the computed number of DAYS from the most recently created review and the ratio of MIN_AVG_DAYS to the average number of days since reviews provided for the service provider were provided by service consumers on lines 1718. In alternative implementations, the routine “reviewRecency” may compute the component score directly from, or partly from, values of fields in the provider data object that describes a service provider, such as the field most_reeent_review_data in a data object of the provider data object type 820 in FIG. 8B.

The routine “reviewQuality” 1802 computes a component score, on line 1804, that represents a weighted average of the average review score to a maximum possible review score, represented by the constant MAX_REVIEW, and the ratio of the number of reviews submitted to the automated system for the service provider to a constant value MAX_REVIEWS. The score is weighted by the weighting factor REVIEW_QUANTITY_AND_QUALITY_WEIGHT. The routine “yearsIn” 1806 returns a computed component score, on line 1808, equal to the ratio of the years that the service provider has been in business to a maximum number of considered years, MAX_YEARS, multiplied by the weighting factor YEARS_IN_BUSINESS_SCORE_WEIGHT. Finally, the routine “subContractor” 1810 returns a component score computed as the number of trades not subcontracted minus the number of trades that are subcontracted divided by the number of trades that are not subcontracted plus the number of trades that are subcontracted, this ratio then multiplied by the weighting factor SUB_CONTRACTOR_TRADES_SCORE_WEIGHT, on line 1812. In alternative implementations, the routine “reviewQuality” may compute the component score directly from, or partly from, values of fields in the provider data object that describes a service provider, such as the fields average_review_rating and number_of_reviews in a data object of the provider data object type 820 in FIG. 8B.

Any of many different alternative methods can be used to compute the component scores computed by the seven routines shown in FIGS. 16-18. The different, alternative methods may use any of various linear and nonlinear computations to produce scores within a possible score range reflective of the above-discussed considerations and characteristics related to service providers.

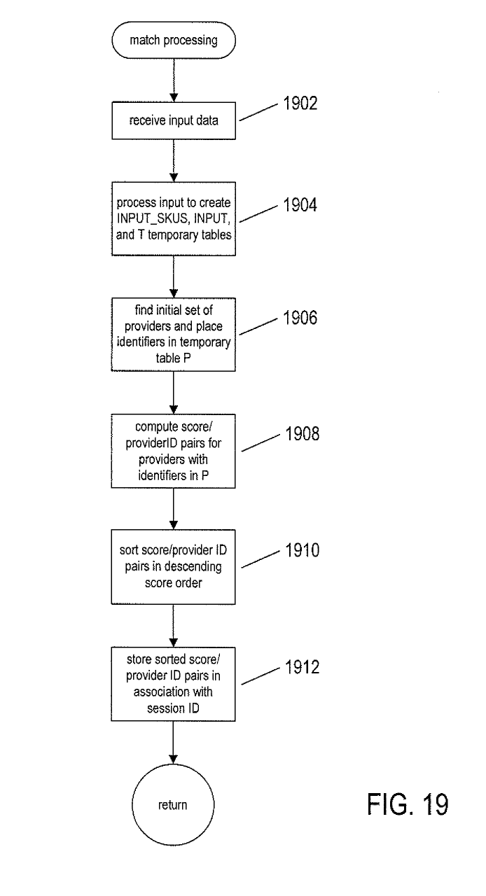

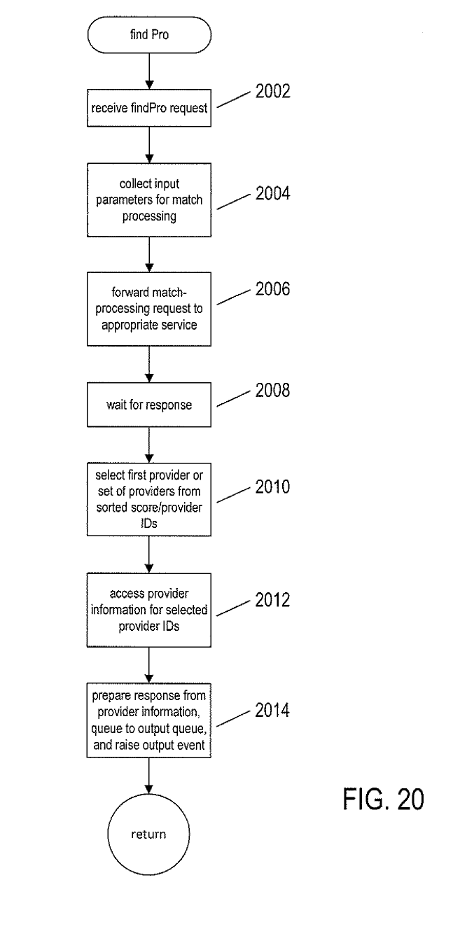

FIGS. 19 and 20 provide control-flow diagrams that illustrate implementation of the processing routine that carries out the service-provider matching process discussed above with reference to FIGS. 11-18. FIG. 19 includes a control-flow diagram for the match-processing routine already described with reference to FIGS. 10-18. In a first step 1902, the match-processing routine receives input data (pseudocode block 1004 in FIG. 10). In step 1904, the match-processing routine processes the input data to create the temporary relational database tables INPUT_SKUS, INPUT, and T, as described above with reference to FIG. 12. In step 1904, the match-processing routine identifies an initial set of candidate providers and places provider identifiers for these candidate providers in the temporary relational-database table P, as discussed above with reference to FIG. 13. As discussed above, the initial candidate service providers are those providers who are currently actively providing services, whose minimum project value is lower or equal to the initial estimate for the service consumer's projects, who provide services in the zip code associated with the location in which service provision is desired by the service consumer, who practice the trades corresponding to the service consumer's project, and who do not have any SKU exclusions for SKUs corresponding to the service consumer's projects. In step 1908, the match-processing routine produces score/provider-identifier pairs for each of the candidate providers identified by identifiers stored in the temporary relational-database table P, as discussed above with reference to FIG. 15. In step 1910, the match-processing routine sorts the score/provider-identifier pairs in descending score order, so that the service providers associated with the highest scores appear first in the list or set of candidate providers. Finally, in step 1912, the sorted score/provider-identifier pairs are stored within the automated system in association with the session identifier for the current session or set of transactions for which the set of sorted candidate providers has been determined by the match-processing routine.

FIG. 20 provides a control-flow diagram for a routine “find Pro” that represents the request handling routine for a request initiated by input of a mouse click to the “find a pro” input feature 142 discussed above with reference to FIG. 1F. In step 2002, the routine receives the “find Pro” request from the main consumer-web loop discussed above with reference to FIG. 9B. In step 2004, the routine collects the input parameters needed for match-processing (1004 in FIG. 4). These input parameters include the session identifier for the current set of transactions between the automated system and the service consumer, the SKUs associated with the items in the service consumer's project list, obtained during previous web-page-based interactions and stored in the automated system in association with the session ID, the customer identifier for the user, and the zip code and project value obtained during previous web-page-based interactions, as discussed above with reference to FIGS. 1A-E. In step 2006, the routine forwards a match-processing request to an appropriate service. In the described implementation, the match-processing request is carried out by the provider-service-application servers (716 in FIG. 7). In step 2008, the routine waits for a response from the service. In step 2010, the routine selects a first candidate provider or a first set of candidate providers from the sorted score/provider-identifier pairs returned by the match-processing service. In step 2012, the routine accesses the service-provider information for the selected service providers from the database using the provider identifiers selected in step 2010. The information for each of the set of highest-scored service providers may be incorporated into a list, such as the list “matchedProviders” 1006 discussed above with reference to FIG. 10. Finally, in step 2014, the routine prepares a response message that includes information for display in the web page discussed above with reference to FIG. 1G, queues the response message to the output queue, and raises an output event.

Although the present invention has been described in terms of particular embodiments, it is not intended that the invention be limited to these embodiments. Modifications within the spirit of the invention will be apparent to those skilled in the art. For example, any of many different implementations for the service-provider matching method incorporated within an automated system can be obtained by varying any of many different implementation and design parameters, including selection of program language or languages, data-storage methods, hardware platforms, operating systems, virtualization layers, control structures, data structures, modular organization, and many other such design and implementation parameters. The matching score produced in the above-described implementation considers numerous different characteristics associated with service providers to select a set of candidate service providers and associate each candidate service provider with a score. In alternative implementations, additional, fewer, and different characteristics and considerations may be employed to select candidate service providers and compute match scores for the candidate service providers. In certain implementations, the criteria used to identify candidate service providers may be relaxed, if an initial search for service providers fails. In these implementations, the automated system may attempt to find multiple service providers that, together, can provide the needed services corresponding to a project list.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A distributed automated system that identifies candidate service providers on behalf of service consumers, the distributed automated system comprising:
multiple virtual servers and data-storage appliances of a virtual data center within a cloud-computing facility, the multiple virtual servers and data-storage appliances implemented within multiple physical computers, each including at least one processor and memory that stores computer instructions executed by the at least one processor, and physical data-storage devices; and
computer instructions, stored in one or more physical memories of one or more of the physical computers within the cloud-computing facility, that, when executed by one or more processors of the one or more of the physical computers within the cloud-computing facility, control the virtual data center to:
receive, by electronic communications, information from a service consumer's processor-controlled electronic device that describes one or more projects which the service consumer seeks to find service providers to carry out,
store, in one or more data-storage appliances, portions of the received project information as well as information computed based on the received project information,
use the received and stored information and additional information already stored and managed by the virtual data center to identify an initial set of candidate service providers that includes those service providers who are currently actively providing services, who provide services in a geographical area corresponding to the geographical area of the one or more projects, whose minimum project value is less or equal to the estimated project value, who have no stored exceptions or exclusions with respect to the one or more projects, and who practice trades involved with to carrying out the one or more projections,
use the received and stored information and the additional information already stored and managed by the virtual data center to assign a match score to each candidate service provider in the initial set of candidate service providers, and
sort the initial set of candidate service providers according to the assigned match scores in order to return, to the service consumer, information about each of one or more service providers in a final set of service providers having those scores indicating the best match between the candidate service providers and the one or more projects.

2. The distributed automated system of claim 1 wherein the portions of the received project information as well as information computed based on the received project information includes:
an estimated project value;
a zip code corresponding to the geographical location of the one or more projects; and
a list of SKUs corresponding to services involved in carrying out the one or more projects.

3. The distributed automated system of claim 1 wherein the information about each of the one or more service providers in the final set of service providers includes:
a provider identifier;
the match score;
a company name;
an owner name;
a license number;
a primary trade;
a number of years of experience;
a number of reviews;
an average review rating; and
a date and time of next availability.

4. The distributed automated system of claim 1 wherein the additional information already stored and managed by the virtual data center includes service-provider information for each of multiple service providers, the service-provider information that described a service provider including:
a minimum project value charged by the service provider;
an indication of whether or not the service provider uses a consumer feedback facility provided by the distributed automated system; and
the year in which the service provider started in business.

5. The distributed automated system of claim 3 wherein the additional information already stored and managed by the virtual data center further includes:
provider-review information that describes reviews provided by service consumers to the distributed automated system for service providers;
provider-trade info nation for each of multiple service providers, the provider-trade information indicating the trades that a service provider provides services within and whether or not each trade that a service provider provides services within is subcontracted;
provider-crew information that describes crew members of a service provider's crew;
provider-crew-schedule information that describes appointment times associated with provider crew members and whether or not each appointment time is available; and
SKU-trade information that describes relationships between SKUs and trades.

6. The distributed automated system of claim 5 wherein the virtual data center assigns a match score to a candidate service provider in the initial set of candidate service providers by:
computing a soonest-available component score;
computing an overall-availability component score;
computing a feedback-user component score;
computing a review-recency component score;
computing a review-quality-and-quantity component score;
computing a years-in-business component score;
computing a subcontracted-trades component score;
combining the soonest-available component score, overall-availability component score, feedback-user component score, review-recency component score, review-quality-and-quantity component score; years-in-business component score, and the subcontracted-trades component score to produce the match score; and
storing the match score in association with an identifier for the candidate service provider.

7. The distributed automated system of claim 6 wherein the soonest-available component score is computed by:
computing a time from the current time to the soonest available appointment time for a member of the candidate service provider's crew, using one or more of the service-provider information, the provider-crew information, and the provider-crew-schedule information;
scaling the computed value to fall in the range [0, 1]; and
multiplying the scaled time by a weighting factor.

8. The distributed automated system of claim 6 wherein the overall-availability component score is computed by:
computing a time value computed based on the total amount of appointment time and the available amount of appointment time, using the service-provider information, the provider-crew information, and the provider-crew-schedule information;
scaling the computed value to fall in the range [0, 1]; and
multiplying the scaled time by a weighting factor.

9. The distributed automated system of claim 6 wherein the feedback-user component score is computed by:
when the candidate service provider uses the feedback facility, as determined from the service-provider information, setting the feedback-user component score to a weighting factor; and
when the candidate service provider does not use the feedback facility, as determined from the service-provider information, setting the feedback-user component score to zero or to a real-number value less than 0.01.

10. The distributed automated system of claim 6 wherein the review-recency component score is computed by:
computing a time from the current time to the time when the most recent consumer review was submitted for the candidate service provider by a consumer to the distributed automated system, using the service-provider information or the provider-review information;
scaling the computed value to fall in the range [0, 1]; and
multiplying the scaled time by a weighting factor.

11. The distributed automated system of claim 6 wherein the review-quality-and-quantity component score is computed by:
computing a value reflective of the number of reviews submitted by consumers for the candidate service provider and the average ratings contained in the reviews, using the service-provider information and/or the provider-review information;
scaling the computed value to fall in the range [0, 1]; and
multiplying the scaled time by a weighting factor.

12. The distributed automated system of claim 6 wherein the years-in-business component score is computed by:
determining a number of years elapsed since the candidate service provider started in business, using the service-provider information;
scaling the computed value to fall in the range [0, 1]; and
multiplying the scaled time by a weighting factor.

13. The distributed automated system of claim 6 wherein the subcontracted-trades component score is computed by:
computing a value reflective of the relative number of the trades involved in carrying out the one or more projects provided by the candidate service provider and number of the trades involved in carrying out the one or more projects, including trades subcontracted by the candidate service provider, using the provider-trade information and the SKU-trade information;
scaling the computed value to fall in the range [0, 1]; and
multiplying the scaled time by a weighting factor.

14. The distributed automated system of claim 5 wherein combining the soonest-available component score, overall-availability component score, feedback-user component score, review-recency component score, review-quality-and-quantity component score; years-in-business component score, and the subcontracted-trades component score to produce the match score further comprises:
adding together the soonest-available component score, overall-availability component score, feedback-user component score, review-recency component score, review-quality-and-quantity component score; years-in-business component score, and the subcontracted-trades component score to produce an initial match score; and
scaling the initial match score to a final match score in the range [80, 100].

15. A method that identifies candidate service providers on behalf of service consumers and that is carried out by a distributed automated system having multiple virtual servers and data-storage appliances of a virtual data center within a cloud-computing facility, the multiple virtual servers and data-storage appliances implemented within multiple physical computers, each including at least one processor and memory that stores computer instructions executed by the at least one processor, and physical data-storage devices, the method comprising:
receiving, by electronic communications, information from a service consumer's processor-controlled electronic device that describes one or more projects which the service consumer seeks to find service providers to carry out,
storing, in one or more data-storage appliances, portions of the received project information as well as information computed based on the received project information,
using the received and stored information and additional information already stored and managed by the virtual data center to identify an initial set of candidate service providers that includes those service providers who are currently actively providing services, who provide services in a geographical area corresponding to the geographical area of the one or more projects, whose minimum project value is less or equal to the estimated project value, who have no stored exceptions or exclusions with respect to the one or more projects, and who practice trades involved with to carrying out the one or more projections,
using the received and stored information and the additional information already stored and managed by the virtual data center to assign a match score to each candidate service provider in the initial set of candidate service providers, and
sorting the initial set of candidate service providers according to the assigned match scores in order to return, to the service consumer, information about each of one or more service providers in a final set of service providers having those scores indicating the best match between the candidate service providers and the one or more projects.

16. The method of claim 15 wherein the portions of the received project information as well as information computed based on the received project information includes:
an estimated project value;
a zip code corresponding to the geographical location of the one or more projects; and
a list of SKUs corresponding to services involved in carrying out the one or more projects.

17. The method of claim 15 wherein the information about each of the one or more service providers in the final set of service providers includes:
a provider identifier;
the match score;
a company name;
an owner name;
a license number;
a primary trade;
a number of years of experience;
a number of reviews;
an average review rating; and
a date and time of next availability.

18. The method of claim 15 wherein the additional information already stored and managed by the virtual data center includes service-provider information for each of multiple service providers, the service-provider information that described a service provider including:
a minimum project value charged by the service provider;
an indication of whether or not the service provider uses a consumer feedback facility provided by the distributed automated system; and
the year in which the service provider started in business.

19. The method of claim 18 wherein the additional information already stored and managed by the virtual data center further includes:
provider-review information that describes reviews provided by service consumers to the distributed automated system for service providers;
provider-trade information for each of multiple service providers, the provider-trade information indicating the trades that a service provider provides services within and whether or not each trade that a service provider provides services within is subcontracted;
provider-crew information that describes crew members of a service provider's crew;
provider-crew-schedule information that describes appointment times associated with provider crew members and whether or not each appointment time is available; and
SKU-trade information that describes relationships between SKUs and trades.

20. The method of claim 19 wherein assigning a match score to a candidate service provider in the initial set of candidate service providers by:
computing a soonest-available component score;
computing an overall-availability component score;
computing a feedback-user component score;
computing a review-recency component score;
computing a review-quality-and-quantity component score;
computing a years-in-business component score;
computing a subcontracted-trades component score;
combining the soonest-available component score, overall-availability component score, feedback-user component score, review-recency component score, review-quality-and-quantity component score; years-in-business component score, and the subcontracted-trades component score to produce the match score; and
storing the match score in association with an identifier for the candidate service provider.
